(19) United States
(12) Patent Application Publication
(10) Pub. No.: US 2023/0001402 A1
(43) Pub. Date: Jan. 5, 2023

(54) IRIDIUM-BASED AMORPHOUS ELECTROCATALYST AND SYNTHESIS OF SAME

(71) Applicant: The Regents of the University of California, Oakland, CA (US)

(72) Inventors: Guangfu Li, Merced, CA (US); Po-Ya Abel Chuang, Merced, CA (US)

(21) Appl. No.: 17/779,840

(22) PCT Filed: Nov. 24, 2020
(86) PCT No.: PCT/US2020/062105

§ 371 Date: May 25, 2022

Related U.S. Application Data
(60) Provisional application No. 62/939,869, filed on Nov. 25, 2019.

(51) Int. Cl. B01J 37/08; B01J 35/00; B01J 37/00; B01J 23/89

(52) U.S. Cl. CPC B01J 37/088; B01J 35/0013; B01J 37/0018; B01J 23/8913

(57) ABSTRACT

A method of fabricating a catalyst material comprises forming or receiving a precursor solution of an iridium precursor compound, adding a 3d orbital transition metal to the precursor solution, adding a surfactant compound to the precursor solution to provide a precursor and surfactant mixture, reacting the iridium precursor compound with a nitrate salt of an alkaline metal cation to provide a reaction product comprising an iridium nitrate, and calcining the iridium nitrate at a specified calcination temperature to convert the iridium nitrate to form catalyst particles comprising an iridium oxide.

### CROSS-REFERENCE TO RELATED APPLICATIONS

This patent application claims the benefit of priority to U.S. Provisional Application Ser. No. 62/939,869, “IRIDIUM-BASED AMORPHOUS ELECTROCATALYST FOR OXYGEN EVOLUTION REACTION AND SURFACTANT-ASSISTED ADAMS FUSION SYNTHESIS OF SAME,” filed on Nov. 25, 2019, which is incorporated by reference herein in its entirety.

### BACKGROUND

Solid polymer electrolyte water electrolysis systems typically include a solid polymer electrolyte membrane that separates a cathode and an anode. Electrons are transported through an external circuit from the anode to the cathode. By controlling the applied potential, water can be electrochemically split to produce hydrogen (H₂) via a hydrogen evolution reaction and oxygen gas (O₂) via an oxygen evolution reaction.

In electrolysis systems, electrocatalysts are often used to expedite half-cell reactions. Compared with the hydrogen evolution reaction, the sluggish oxygen evolution reaction at the anode typically has been a major source of overpotential in the whole electrolyzer. Iridium has typically served as an active component for high-efficiency and robust oxygen evolution reaction. Nevertheless, there is a low abundance of iridium and the process of mining iridium is often arduous, such the price of iridium is quite high. For this reason, availability and cost of iridium is considered to be a major drawback for large scale applications of solid polymer electrolyte water electrolysis.

A large variety of synthesis methods have resulted in the presence of various iridium-based catalysts, ranging from homogeneous molecular catalysts to heterogeneous nanoparticles, films, or bulk catalysts. Catalytic activity of an iridium-based catalyst is strongly dependent on the structure of the iridium-containing compound, and the catalytic activity is, therefore, strongly dependent on the catalyst's synthesis procedure. Heterogeneous iridium-based catalysts comprise different types of amorphous, hydrous oxide materials as well as crystalline oxides such as perovskites, pyrochlores, or hollandites. Crystalline rutile iridium oxide (IrO₂) has been widely used as an oxygen evolution reaction electrocatalyst. Rutile iridium oxide has exhibited high stability and a low dissolution rate, which is believed to be attributable to the formation of a dense and crystalline film with low electrolyte accessibility to the reaction interface. However, the compact crystalline layer leads to low overall mass activity since only the outer surface at the solid-liquid interface is available for the oxygen evolution reaction. Compared with rutile iridium oxide, few attempts have involved the use of amorphous iridium oxides even though amorphous iridium has been found to have higher oxygen evolution reaction activity because amorphous materials usually have severe stability issues due to enhanced dissolution rates of active metals during operation.

Iridium-based oxides have been produced through a large variety of approaches. The Adams fusion method is a fast, convenient, and well-known way for large-scale production of uniform performance oxide powders. Unfortunately, oxides fabricated by the traditional Adams fusion method have not achieved satisfactory performance because the powders are known to undergo sintering and aggregation. Thermal decomposition is another well-known method of iridium oxide production, but it has typically resulted in poor control over the composition and microstructure, both of which are important for catalyst performance. Novel synthesis methods have been tried in an attempt to obtain better control over structure and to improve the properties of prepared iridium-based oxides. These newly developed methods have included solvothermal routes, soft/hard templates, magnetron sputtering, and liquid atomic layer deposition. Although many of these attempts have achieved good laboratory results, there has yet to be a satisfactory upscaling to large-scale industrial production, typically because of uncertainty and nonconformity of the formed particles.

### SUMMARY

The present disclosure describes a process for fabricating an electrocatalyst, and in particular an iridium-based oxide particulate electrocatalyst with an amorphous structure that is suitable for high-efficiency and robust oxygen evolution reaction in both acidic and alkaline media. The electrocatalyst material described herein can be used on the anode side of a solid polymer electrolyte water electrolyzer, including in proton exchange membrane electrolysis systems and anion exchange membrane electrolysis systems. The process of the present disclosure allows for fine tuning of the final size, shape, and composition of the resulting iridium-based catalyst, which can improve iridium utilization and endurance with strong resistance to corrosion in both acid and alkaline conditions.

The procedure described herein is a modified version of the Adams fusion method. In an example, the Adams fusion method typically involves the formation of iridium-containing nitrates by reacting aqueous metallic precursors with alkaline-metal nitrate, and then calcination of the resulting reaction product in an oxygen/air environment at a temperature of from about 200° C. to about 600° C. In an example, the process includes adding a surfactant into the aqueous catalyst metal precursor prior to adding alkaline-metal nitrate. The surfactant molecules undergo microphase separation and can self-organize into aggregated micelles, which can serve as soft templates to control the formation of nanoparticles during synthesis.

### BRIEF DESCRIPTION OF THE DRAWINGS

The drawings illustrate generally, by way of example, but not by way of limitation, various embodiments discussed in the present document.

FIG. 1A is schematic cross-sectional diagram of an example proton exchange membrane water electrolyzer that can use an iridium-based oxygen evolution reaction catalyst according to various embodiments of the present disclosure.

FIG. 1B is schematic cross-sectional diagram of an example alkaline exchange membrane water electrolyzer that can use an indium-based oxygen evolution reaction catalyst, according to various embodiments of the present disclosure.

FIG. 2 is a flow diagram of an example process for fabricating an indium-based catalyst, according to various embodiments of the present disclosure.

FIG. 3 is a view of a hypothetical scenario within a reaction solution as part of the process for fabricating the iridium-based catalyst of FIG. 2 wherein a surfactant forms small micelles that include an iridium nitrate intermediate compound, according to various embodiments of the present disclosure.

FIG. 4 is a view of a hypothetical scenario within a reaction solution as part of the process for fabricating the iridium-based catalyst of FIG. 2 wherein the micelles of the surfactant and iridium nitrate intermediate have aggregated to form larger micelles, according to various embodiments of the present disclosure.

FIG. 6 is a schematic view of particles of iridium-based catalyst made by the example process of FIG. 2 wherein a portion of a 3d transition metal is being removed from the particles by acid etching, according to various embodiments of the present disclosure.

FIG. 6 is a schematic view of particles of iridium-based catalyst made by the example process of FIG. 2 wherein all of the 3d transition metal is being removed from the particles by acid etching, according to various embodiments of the present disclosure.

FIG. 7 is graph of x-ray diffraction patterns of samples of iridium-based catalyst doped with the 3d transition metal cobalt made by the processes described in EXAMPLES 1-3 and COMPARATIVE EXAMPLE 4.

FIGS. 8A-8D are transmission electron microscopy images of the iridium-based catalyst made by the processes described in EXAMPLES 1-3 and COMPARATIVE EXAMPLE 4.

FIG. 9 is graph of linear sweep voltammetry testing for the oxygen evolution reaction in the electrochemical cells using samples of iridium-based catalyst doped with the 3d transition metal cobalt, as described in EXAMPLES 6-8 and COMPARATIVE EXAMPLE 9 and for the electrochemical cell using the non-doped iridium-based catalyst of COMPARATIVE EXAMPLE 10.

FIG. 10 is a graph showing the change between initial activity for the oxygen evolution reaction and the activity for the oxygen evolution reaction after 2000 cycles of cyclic voltammetry in the electrochemical cells using samples of iridium-based catalyst doped with the 3d transition metal cobalt, as described in EXAMPLES 6-8 and COMPARATIVE EXAMPLE 9 and for the electrochemical cell using the non-doped indium-based catalyst of COMPARATIVE EXAMPLE 10.

FIG. 11 is graph of x-ray diffraction patterns of samples of iridium-based catalyst doped with the 3d transition metal cobalt made using different nitrate salts, as described in EXAMPLES 1, 6, and 7.

FIG. 12 is a graph of linear sweep voltammetry testing for the oxygen evolution reaction in the electrochemical cells using samples of iridium-based catalyst doped with the 3d transition metal cobalt made using potassium nitrate as the nitrate sale (EXAMPLE 1) and sodium nitrate as the nitrate salt (EXAMPLE 6) and using a commercially-available iridium-based catalyst.

FIG. 13 show ohmic-corrected Tafel plots of the catalyst activity for the oxygen evolution reaction in the electrochemical cells using samples of iridium-based catalyst doped with the 3d transition metal cobalt made using potassium nitrate as the nitrate sale (EXAMPLE 1) and sodium nitrate as the nitrate salt (EXAMPLE 6) and using a commercially-available iridium-based catalyst.

### DETAILED DESCRIPTION

The following detailed description includes references to the accompanying drawings, which form a part of the detailed description. The drawings show, by way of illustration, specific embodiments in which the invention may be practiced. These embodiments, which are also referred to herein as “examples,” are described in enough detail to enable those skilled in the art to practice the invention. The example embodiments may be combined, other embodiments may be utilized, or structural, and logical changes may be made without departing from the scope of the present invention. While the disclosed subject matter will be described in conjunction with the enumerated claims, it will be understood that the exemplified subject matter is not intended to limit the claims to the disclosed subject matter. The following detailed description is, therefore, not to be taken in a limiting sense, and the scope of the present invention is defined by the appended claims and their equivalents.

References in the specification to “one embodiment”, “an embodiment,” “an example embodiment,” etc., indicate that the embodiment described can include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a concentration range of “about 0.1% to about 5%” should be interpreted to include not only the explicitly recited concentration of about 0.1 wt. % to about 5 wt. %, but also the individual concentrations (e.g., 1%, 2%, 3%, and 4%) and the sub-ranges (e.g., 0.1% to 0.5%, 1.1% to 2.2%, and 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. Unless indicated otherwise, the statement “at least one of” when referring to a listed group is used to mean one or any combination of two or more of the members of the group. For example, the statement “at least one of A, B, and C” can have the same meaning as “A; B; C; A and B; A and C; B and C; or A, B, and C,” or the statement “at least one of D, E, F, and G” can have the same meaning as “D; E; F; G; D and E; D and F; D and G; E and F; E and G; F and G; D, E, and F; D, E, and G; D, F, and G; E, F, and G; or D, E, F, and G.” A comma can be used as a delimiter or digit group separator to the left or right of a decimal mark; for example, “0.000,1” is equivalent to “0.0001.”

In the methods described herein, the steps can be carried out in any order without departing from the principles of the invention, except when a temporal or operational sequence is explicitly recited. Furthermore, specified steps can be carried out concurrently unless explicit language recites that they be carried out separately. For example, a recited act of doing X and a recited act of doing Y can be conducted simultaneously within a single operation, and the resulting process will fall within the literal scope of the process. Recitation in a claim to the effect that first a step is performed, and then several other steps are subsequently performed, shall be taken to mean that the first step is performed before any of the other steps, but the other steps can be performed in any suitable sequence, unless a sequence is further recited within the other steps. For example, claim elements that recite “Step A, Step B, Step C, Step D, and Step E” shall be construed to mean step A is carried out first, step E is carried out last, and steps B, C, and D can be carried out in any sequence between steps A and E (including with one or more steps being performed concurrent with step A or Step E), and that the sequence still falls within the literal scope of the claimed process. A given step or sub-set of steps can also be repeated.

Furthermore, specified steps can be carried out concurrently unless explicit claim language recites that they be carried out separately. For example, a claimed step of doing X and a claimed step of doing Y can be conducted simultaneously within a single operation, and the resulting process will fall within the literal scope of the claimed process.

The term “about” as used herein can allow for a degree of variability in a value or range, for example, within 10%, within 5%, within 1%, within 0.5%, within 0.1%, within 0.05%, within 0.01%, within 0.005%, or within 0.001% of a stated value or of a stated limit of a range and includes the exact stated value or range.

The term “substantially” as used herein refers to a majority of, or mostly, such as at least about 50%, 60%, 70%, 80%, 90%, 95%, 96%, 97%, 98%, 99%, 99.5%, 99.9%, 99.99%, or at least about 99.999% or more, or 100%.

In addition, it is to be understood that the phraseology or terminology employed herein, and not otherwise defined, is for the purpose of description only and not of limitation. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference should be considered supplementary to that of this document; for irreconcilable inconsistencies, the usage in this document controls.

### Solid Polymer Electrolyte Water Electrolyzers

Solid polymer electrolyte water electrolysis (also referred to hereinafter as “SPEWE”) with a zero-gap configuration appears to be a very promising method of clean hydrogen production in order to provide a sustainable energy source. In some examples, SPEWE electrolyzers include a cathode from which hydrogen gas evolves and an anode from which oxygen gas evolves. The anode and cathode are separated by a membrane comprising a solid polymer electrolyte (also referred to as “SPE”) that conducts ions (such as protons (H⁺) or hydroxyl ions (OH⁻)) from one of the electrodes to another. In one type of electrolyzer, the SPE is a proton exchange membrane (also referred to hereinafter as “PEM”) that conducts protons (H⁺ in the form of hydronium ions (HaO⁺)) from the oxygen-evolving anode to the hydrogen-evolving cathode. In another type of electrolyzer, the SPE is an alkaline exchange membrane (also referred to hereinafter as “AEM”) that conducts hydroxyl ions (OH⁻) from the hydrogen-evolving cathode to the oxygen-evolving anode.

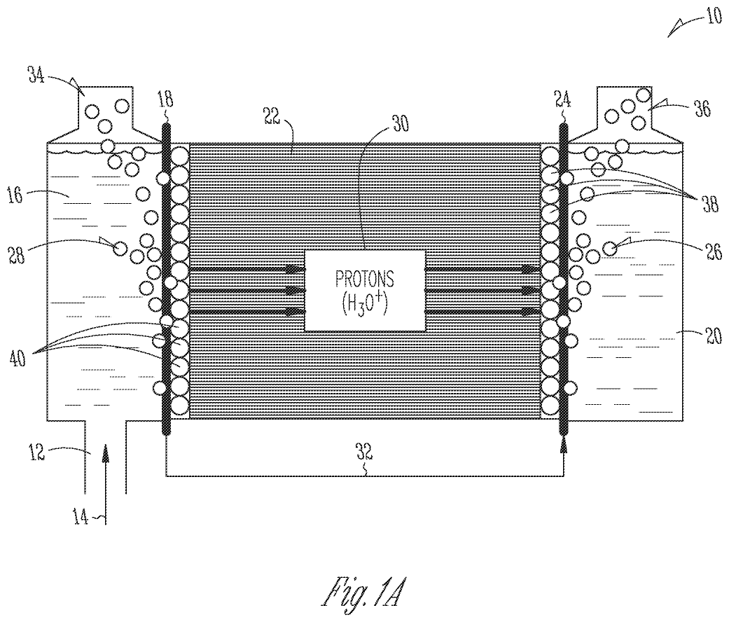

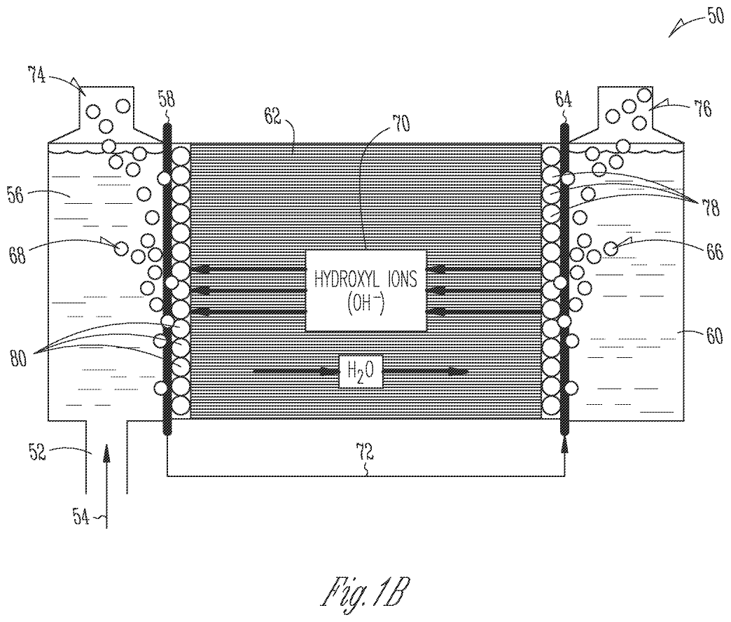

FIG. 1A is a schematic cross-sectional diagram of an example proton exchange membrane water electrolyzer 10 (also referred to hereinafter as “the PEMWE 10” for the sake of brevity). The PEMWE 10 includes a feed inlet 12 through which water 14 (also referred to as “H₂O 14”) is fed into the PEMWE 10. In an example, the H₂O feed inlet 12 feeds the water 14 into an anode chamber 16, where the water 14 can come into contact with an anode 18. The anode chamber 16 is separated from a corresponding cathode chamber 20 by a proton exchange membrane 22 (also referred to as “the PEM 22”), wherein water 14 in the cathode chamber 20 can come into contact with a cathode 24. By controlling the applied potential across the anode 18 and the cathode 24, the H₂O in the anode chamber 16 and the cathode chamber 20 can be chemically split to produce evolved hydrogen gas 26 (also referred to herein as “H₂ gas 26”) at the cathode 24 and evolved oxygen gas 28 (also referred to herein as “O₂ gas 28”) at the anode 18. The O₂ gas 28 is produced by an oxygen-evolving reaction (also referred to herein as “the OER” for the sake of brevity) (Reaction [A] below) that occurs at the anode 18. The protons 30 (H⁺) of the OER [A] are conducted through the PEM 22, either as H⁺ ions or in the form of hydronium ions (also referred to herein as “H₃O⁺ ions” to the cathode 24. At the cathode 24, the protons 30 react to form the evolved H₂ gas 26 in a hydrogen-evolving reaction (also referred to herein as “the HER” for the sake of brevity) (Reaction [B] below).

H₂O→H⁺O₂+4e⁻ [A]

4H⁺+2e⁻→4H₂ [B]

The electrons generated via the OER (Reaction [A]) are transported through a conductive circuit 32 from the anode 18 to the cathode 24, where they react with the protons 30 that had been conducted through the PEM 22 to generate the H₂ gas 26. In an example, the O₂ gas 28 evolved by the OER (Reaction [A]) at the anode 18 bubbles up through the water present in the anode chamber 16, where it can exit the PEMWE 10 via an oxygen gas outlet 24. Similarly, in an example, the H₂ gas 26 evolved by the HER (Reaction [B]) at the cathode 24 bubbles up through the water present in the cathode chamber 20, where it can exit the PEMWE 10 via a hydrogen gas outlet 36.

The PEMWE 10 can also include a first catalyst 38 located at or proximate to the cathode 24 to facilitate the HER (Reaction [B]), which will also be referred to herein as the “HER catalyst 38,” and a second catalyst 40 located at or proximate to the anode 18 to facilitate the OER (Reaction [A]), referred to hereinafter as the “OER catalyst 40.”

FIG. 1B is a schematic a schematic cross-sectional diagram of an example alkaline exchange membrane water electrolyzer 50 (also referred to hereinafter as “the AEMWE 50” for the sake of brevity). Similar to the PEMWE 10, the AEMWE 50 includes a feed inlet 52 through which water 54 (also referred to hereinafter as “H₂O 54”) is fed into the AEMWE 50, for example into an anode chamber 56 where the H₂O 54 can come into contact with an anode 58. Like the PEMWE 10, the AEMWE anode chamber 56 is separated from a corresponding cathode chamber 60 by an alkaline exchange membrane 62 (also referred to herein as “the AEM62”), wherein the water 54 can come into contact with a cathode 64. By controlling the applied potential across the anode 58 and the cathode 64, the H₂O 54 in the anode and cathode chambers 56, 60 is chemically split to produce evolved hydrogen gas 66 (also referred to herein as “H₂ gas 66”) at the cathode 64 and evolved oxygen gas 68 (also referred to herein as “O₂ gas 68”) at the anode 58.

Water 54 in the cathode chamber 60 is split via a hydrogen-evolution reaction (also referred to as “HER”) (Reaction [C] below) to provide the evolved H₂ gas 66 and hydroxyl ions 70 (also referred to as “OH⁻ ions 70”) OH⁻ ions 70 produced by the HER at the cathode 64 (Reaction [C]) are conducted through the AEM 62 to the anode 58, where the OH⁻ ions 70 react to form water and the evolved O₂ gas 68 via an oxygen-evolution reaction (also referred to herein as “the OER”) (Reaction [D] below).

4H₂O+4e⁻→4OH⁻+2H₂ [C]

4OH₋→2H₂O+O₂+4e⁻ [D]

The electrons generated by the OER (Reaction [D]) are transported through a conductive circuit 72 from the anode 58 to the cathode 64, where they act to electrolytically split water in order to generate the H₂ gas 64 in the cathode chamber 60 and the OH⁻ ions 70 that are conducted through the AEM 62. In an example, the O₂ gas 68 evolved by the OER (Reaction [D]) at the anode 58 bubbles up through the anode chamber 56, where it can exit the AEMWE 50 via an oxygen gas outlet 74. Similarly, in an example, the H₂ gas 66 evolved by the HER (Reaction [C]) at the cathode 64 bubbles up through the cathode chamber 60, where it can exit the AEMWE 50 via a hydrogen gas outlet 76.

Also similar to the PEMWE 10, the AEMWE 50 can include one or both of a HER catalyst 78 located at or proximate to the cathode 64 to facilitate the HER (Reaction [C]) and an OER catalyst 80 located at or proximate to the anode 58 to facilitate the OER (Reaction [D]). In some examples, the OER catalyst 80 used in the AEMWE 50 of FIG. 1B can be the same catalyst material as the OER catalyst 40 used in the PEMWE 10 of FIG. 1A, or it can be a different catalyst material. Similarly, in some examples, the HER catalyst 78 used in the AEMWE 50 of FIG. 1B can be the same catalyst material as the HER catalyst 38 used in the PEMWE 10 of FIG. 1A, or it can be a different catalyst material.

Solid polymer electrolyte water electrolysis devices with a zero-gap configuration, such as the example PEMWE 10 and the AEMWE 50 described above, hold the promise of clean hydrogen production coupled with sustainable energy sources. Typical low-temperature SPEWE systems have advantages over traditional alkaline liquid electrolysis. PEM electrolysis has been found to exhibit remarkable advantages in terms of efficiency, current density, and high-pressure operation. Recent progress in the area of high-performance anion exchange ionomers have promoted the development of AEMWE devices. AEM electrolysis have been competitive, even compared with PEM technology. Many advantages are achievable with AEMWE devices, such as gas purity, high current density, and non-noble metal catalysts. The Ir-based catalyst of the present disclosure can be used as a bifunctional catalyst in both the example PEMWE 10 of FIG. 1A and the example AEMWE 50 of FIG. 1B, which could be an important breakthrough if electrode materials can be simultaneously optimized for the use in both PEM and AEM operational modes. Such a bifunctional catalyst for acidic and alkaline OERs are virtually unknown.

### Improved IR-Based Catalyst Material

The remainder of the present disclosure is directed toward iridium-based (also referred to hereinafter as “Ir-based” for the sake of brevity) catalyst materials that can be used as the OER catalyst in either a PEMWE, such as the OER catalyst 40 in the example PEMWE 10 of FIG. 1A, or in an AEMWE, such as the OER catalyst 80 in the example AEMWE 50 of FIG. 1B. As noted above, Iridium (which will also be referred to by its shortened elemental symbol “Ir”) has typically served as an active component for OER catalysis. However, Ir, like most OER electrocatalysts, has not typically had adequate stability in both acidic and alkaline conditions.

The fabrication processes described herein produce an Ir-based catalyst material that can be used at the anode under acidic conditions, e.g., those that are typical at the anode in a PEMWE, and also in alkaline conditions, e.g., those that are typical at the anode in an AEMWE. The catalyst material produced by the processes described herein have been found to comprise an amorphous, porous, and Ir-enriched surface structure that results in improved catalytic activity compared to previously reported Ir-based catalysts for use as an OER catalyst in water electrolysis. The catalyst materials provided by the processes described herein include either a non-crystalline structure or a structure with poor crystallinity, which leads to a material with structural flexibility and substantial surface defects that promote high efficiency for the OER as catalyzed by the Ir-based catalyst material. The Ir-based catalysts described herein have also been found to have long-term stability during the OER of water electrolysis compared to previously reported Ir catalysts.

In addition, the catalyst fabrication processes described herein can, in some examples, provide for controlled tuning of catalyst particle size, physical properties (such as shape or porosity), and composition to improve catalytic utilization of the iridium in the catalyst material, as well as stability and endurance of the catalyst against corrosion in both strongly acidic and strongly alkaline environments during electrolysis.

### Fabrication Process for Catalyst Material

As mentioned above, the process for fabricating the Ir-based catalyst material is a modified version of the Adams fusion method of forming metal oxides. As will be appreciated by those having skill in the art, Adams fusion traditionally involves the formation of a metal-containing nitrate intermediate by reacting an aqueous metal precursor compound and an alkaline-metal nitrate. In the case of a process to form an iridium oxide, a typical Adams fusion process would react an aqueous iridium precursor with an alkaline metal nitrate to provide an Ir-containing nitrate. Next, the Adams fusion process typically comprises calcining the metal nitrate intermediate in an oxygen and air environment at a specified temperature to convert the metal nitrate intermediate to particulate metal oxide. While traditional Adams fusion has shown promising potential for the industrial production of fine metal oxide powder, oxides fabricated by the traditional method do not typically exhibit high catalytic performance because the particles usually experience serious sintering and particle aggregation during calcination.

A primary difference between the process of the present disclosure compared to traditional Adams fusion is the addition of a surfactant compound into the aqueous metal precursor solution prior to its reaction with the alkaline metal nitrate to form the metal nitrate, e.g., the Ir nitrate intermediate in the case of the formation of Ir-based catalysts. Without wishing to be bound by any theory, the inventors believe that molecules of the surfactant compound undergo microphase separation within the aqueous precursor solution, which can, under certain conditions, self-organize into aggregated micelles. The self-organized micelles can then serve as soft templates to control the formation of the nitrate intermediate during reaction of the metal precursor with the alkaline nitrate and to control the formation of oxide particles during calcination.

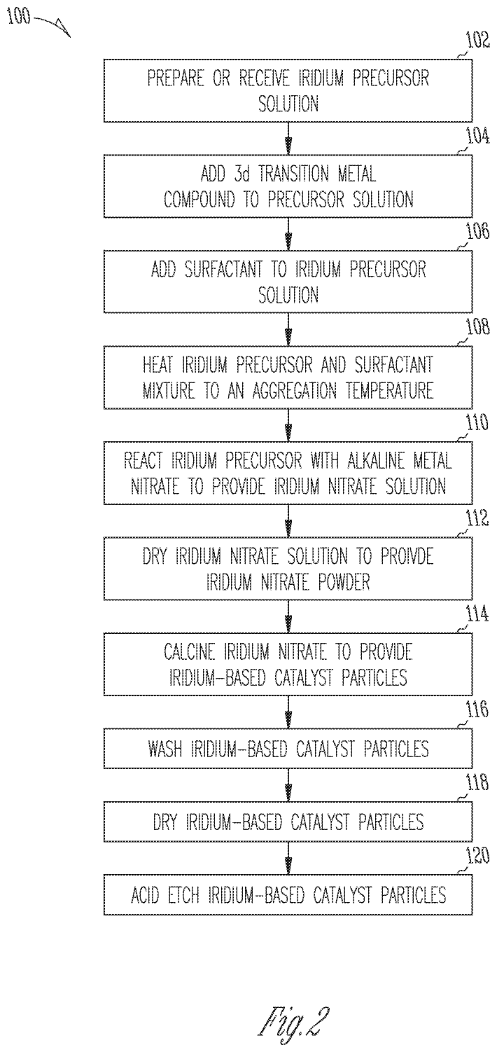

FIG. 2 is a flow diagram of an example process 100 of fabricating a metal-based catalyst material, and in particular an Ir-based catalyst material according to the present disclosure. For the sake of brevity, the process 100 of FIG. 2 will be described in the context of fabricating an Ir-based catalyst for the OER in a water electrolyzer, such as in one of the example SPEWEs 10, 50 described above. However, those having skill in the art will appreciate that a similar process can be used to form other metal oxide catalyst materials without varying from the scope of the present disclosure. For example, those having skill in the art will appreciate that a similar or identical process can be used to form other metal oxide particles (either doped or undoped), including, but not limited to, ruthenium (IV) oxide (RuO₂), platinum oxide (PtO₂), transition metal oxides (including, but not limited to, oxides of manganese (Mn), iron (Fe), cobalt (Co), nickel (Ni), copper (Cu), gold (Au), silver (Ag), vanadium (V), molybdenum (Mo), rhodium (Rh), palladium (Pd), cadmium (Cd), tungsten (W), and rhenium (Re)), and combinations thereof. In addition to the oxygen-evolution reactions for which the Ir-based catalyst is described herein, the fabrication process can be used to form catalyst materials for other types of reactions, including, but not limited to, hydrogenation, hydrogenolysis, dehydrogenation, or oxidation reactions.

The catalyst fabrication process of FIG. 2 includes, at step 102, forming or receiving an iridium precursor solution (also referred to hereinafter as “the Ir precursor solution” for brevity). In an example, the Ir precursor solution the results from step 102 comprises a solution of an iridium precursor compound (also referred to hereinafter as “the Ir precursor compound” or simply “the Ir precursor” for brevity), including, but not limited to, inorganic Ir-containing compounds or organic Ir-containing compounds. Examples of inorganic compounds that can be used as the Ir-containing precursor compound in step 102 of the process 100 include, but are not limited to, a hydrogen haloiridate (e.g., hydrogen hexachloroiridate (IV) (H₂IrCl₆), also referred to as hexachloroiridic acid, or hydrogen hexabromoiridate (H₂IrBr₆)) or a substituted hydrogen hexahaliridate (such as potassium hexachloroiridate (K₂IrCl₆), sodium hexachloroiridate (Na₂IrCl₆), cesium hexachloroiridate (Cs₂IrCl₆)), or other inorganic Ir-containing compounds (such as iridium chloride (IrCl₃) or iridium nitrate (Ir(NO₃)₃). Examples of organic Ir-containing compounds that can be used as the Ir-containing precursor compound in step 102 of the process 100 include, but are not limited to, soluble Ir-containing organics, including, but not limited to, indium (III) acetylacetonate, bis(1,5-cyclooctadiene)iridium(I) tetrafluoroborate, chloro(1,5-cyclooctadiene)iridium(I) dimer, and methoxy(1,5-cyclooctadiene)iridium(I) dimer.

In some examples, the process can include, at step 104, adding to the solution a compound comprising a transition metal with a partially filled d orbital sub-shell to the precursor solution prepared or received in step 102. The partially-filled d orbital sub-shell of the transition metal compound used in step 104 can also be referred to as the “3d orbital,” such that the transition metal will also be referred to hereinafter as a “3d orbital transition metal” or simply a “3d transition metal,” and the compound added to the solution in step 104 will also be referred to hereinafter as a “3d orbital transition metal compound.” The addition of the 3d transition metal compound to the precursor solution provides a doped iridium-based catalyst material at the completion of the fabrication process. In an example, the 3d transition metal that is used to dope the Ir-based catalyst material, e.g., the transition metal that is part of the added compound, comprises a transition metal in Period 4 (i.e., the fourth row) of the periodic table, specifically one or more of the transition metals from atomic number 21 up to and including atomic number 31. In an example, the doping metal comprises at least one of scandium (Sc), titanium (Ti), vanadium (V), chromium (Cr), manganese (Mn), iron (Fe), cobalt (Co), nickel (Ni), copper (Cu), zinc (Zn), and combinations thereof.

In an example, the 3d transition metal compound that is added to the precursor solution in step 104 is soluble in water or a water mixed solvent. In an example, the transition metal compound can comprise an inorganic salt (e.g. a metal halogen, metal sulfate, metal carbonate, or metal nitrate) or an organic salt (e.g. a metal acetylacetone or a metal acetate) of the 3d orbital transition metal. In an example, when the aqueous compound is added to the precursor solution, the 3d transition metal compound becomes the ionic form with uniform dispersion.

In an example, the 3d transition metal compound that is added to the precursor solution has the general formula [1]:

MXₐ [1]

where M is at least one 3d transition metal as defined above (e.g., a transition metal in Period 4 of the periodic table, such as one or more of the transition metals from atomic number 21 up to and including atomic number 31), X is a corresponding salt, including inorganic salts such as a halogen (e.g., chlorine (Cl), fluorine (F), iodine (I), or bromine (Br)), sulfate, carbonate, or nitrate, or organic salts such as acetylacetones or acetates, and a is an integer that is either 1, 2, 3, 4, or 5. In an example, when the 3d transition metal compound is added to the precursor solution, it becomes the hydrated ion form of the compound, e.g., CoCl₂ becomes CO²⁺ and Cl⁻.

In an example, the molar ratio of the Ir precursor compound (e.g., H₂IrCl₆) added to the precursor solution relative to 3d transition metal compound added to the precursor solution is from about 9:1 to about 1:9, for example from about 6:4 to about 4:6, for example about 1:1. The ratio of the Ir precursor compound relative to the 3d transition metal in the precursor solution can be selected to modulate the amount of the 3d transition metal present in the final catalyst particles, which in turn can modulate the chemisorption energy of oxygen onto or into the catalyst particle. As will be appreciated by those having skill in the art, the chemisorption energy of oxygen typically is a rate-limited parameter in OER catalysis. Therefore, doping the Ir-based catalyst with the 3d transition metal can enhance the effective utilization of the iridium, reduce the amount of iridium needed to achieve the same activity, and can tune the d-orbital distribution of iridium's 5d electrons to favor atomic oxygen adsorption (O_{ad}), and possibly the adsorption of caboxyl oxygen (OOH_{ad}), rather than the hydroxyl (OH_{ad}) at the reaction interface.

In an example, the doped Ir catalyst particles resulting from steps 102 and 104 have the general formula [2]:

Ir_{X}M₁₋ₓO_{y} [2]

where x is a number more than 0 and less than 1, M includes at least one 3d transition metal (as defined above), and y is a number less than 2, depending on the specific 3d transition metal used and the metal oxidation state. In some examples, a value of x from about 0.1 to about 0.9, for example from about 0.4 to about 0.6, has been found to be particularly effective for the OER in SPEWEs.

As described above, typically Ir-based catalysts have experienced stability problems during electrolysis due to the substantially continuous dissolution of Ir during operation. The doping of the 3d transition metal (M) into or onto the Ir-based particle can allow for some level of control over dissolution of the 3d transition metal over dissolution of the Ir active material during electrolysis, which in turn can allow the resulting catalyst particles to have a specified surface topography that more effectively exposes active Ir sites more efficiently and stably compared to comparable, non-doped Ir-based particles. The addition of the 3d transition metal has also been found to make it more likely that the final Ir-based material will be amorphous rather than crystalline or mixed crystal. Finally, the inventors also believe that the chemical reconstruction that takes place with the addition of the 3d transition metal dopant can lead to higher activity due to increased charge conductivity and improved adsorption of reaction intermedia during OER.

In an example, the process 100 includes, at step 106, adding a surfactant compound to the Ir precursor solution to provide an Ir precursor and surfactant mixture. In an example, the surfactant compound is added to the Ir precursor solution in an amount that is sufficient so that the surfactant undergoes microphase separation with the Ir precursor solution such that the surfactant self-organizes into aggregated micelles. In an example, the molar ratio of the surfactant compound relative to the combined concentration of the Ir and the 3d transition metal compound is from about 0.001 to about 0.5, for example about 0.01. However, the optimum ratio for a particular mixture can depend strongly on the specific surfactant compound used.

The formation and aggregation of the micelles can be dispersed with, entrap, encapsulate, or attach to the nanoparticle matrix of the Ir-based compounds that are to form the catalyst particles, which can allow for the formation of Ir-based catalyst particles with well-defined shapes, size, physical state, and surface properties. As noted above, without wishing to be bound by any particular theory, the inventors believe these aggregated micelles can serve as a soft template to control the formation of the iridium nitrate intermediate during the reaction step (step 110, described below) and the formation of iridium oxide during the calcination step (step 114, described below). It is also believed that the presence of surfactant can substantially alter the pathway of crystallization by the Ir oxide because the surfactant micelles lower barriers to nucleation due to a reduction in the interfacial free energy, which results in increased amounts of nucleation that efficiently prevents the formation of large-size crystallite and promotes the transition from crystalline to amorphous structure for the final Ir-based catalyst. The inventors have also found that the present of surfactant can suppress sintering and particle aggregation, even at calcination temperatures as high as 600° C. Crystal growth by particle attachment is also well controlled, which prevents or minimizes bulk crystal formation. Instead, the resulting amorphous particles have higher electrocatalytic activity, ascribing to the structural flexibility and enhanced surface defects. It is also believed that the addition of surfactant aids surface control of the catalysts over structure and composition, which dominate the OER properties. Finally, the inventors have found that the presence of aggregated surfactant micelles result in a self-assembled organic layer that surrounds the Ir precursor during reaction to form the Ir nitrate, with the organic layer preventing or minimizing aggregation by the Ir precursor compound before reaction (step 110, described below), aggregation by the Ir nitrate formed after reaction, or aggregation by the Ir oxide during calcination (step 114, described below). The presence of the surfactant leads to the formation of catalyst particles with a smaller size and more controllable size range compared to particles formed without the use of the surfactant. In some examples, the micelles that are formed by the surfactant have a diameter of from about 10 nm to about 200 nm.

In an example, the surfactant compound that is added to the Ir precursor solution in step 106 comprises an amphiphilic compound, i.e., a compound having both hydrophilic groups and hydrophobic groups. In an example, the amphiphilic surfactant comprises a compound with a hydrophilic end group (e.g., a hydrophilic head) and a hydrophobic body group (e.g., a hydrophobic tail). In a more specific example, the surfactant compound comprises a relatively long-chain molecule (e.g., a long-chain polymer) with hydrophilic groups at both ends and a hydrophobic middle group between the hydrophilic end groups. In an example, the surfactant molecules comprise a nonionic triblock copolymer (also referred to hereinafter as a “TBP”) comprising hydrophilic blocks at the ends of the polymer chain and a hydrophobic block between the hydrophilic end blocks, which can be described in a shorthand notation as “a hydrophilic-hydrophobic-hydrophilic triblock polymer.” or a “hydrophilic-hydrophobic-hydrophilic TBP.” In a specific example, the surfactant comprises a poly(ethylene oxide)-poly(propylene oxide)-poly(ethylene oxide) triblock polymer (also referred to hereinafter as a “PEO-PPO-PEO TBP”).

The inventors have found that, surprisingly, the amount of the hydrophilic blocks (e.g., the PEO blocks in a PEO-PPO-PEO TBP) relative to the hydrophobic blocks (e.g., the PPO block in a PEO-PPO-PEO TBP) has a direct influence over the structure and stability of the resulting Ir-based catalyst particles. In particular, the inventors have found that as the ratio of the hydrophobic blocks relative to the hydrophilic blocks increases (e.g., when the relative amount of the PPO blocks in the surfactant molecules increases), it results in more well-defined and stable micelles during the aggregation portion of the process (described in more detail below). On the other hand, when the reverse occurs, i.e., when the ratio of the hydrophilic blocks relative to the hydrophobic blocks increases (e.g., when the relative amount of the PEO blocks in the surfactant molecules increases), it helps to achieve a greater number of surface cavities, e.g., a higher porosity in the Ir-based catalyst particles. Also, when the relative amount of the hydrophilic blocks is higher, water can be a good solvent for the surfactant compound at room temperature. In an example, the relative weight of the PEO blocks in a PEO-PPO-PEO TBP, is defined by Equation [3]:

$${W}_{PEO} = \frac{wt {\%}_{PEO}}{wt {\%}_{PEO} + wt {\%}_{PPO}} \qquad [ 3 ]$$

where W_{PEO} is defined as the relative weight of the PEO blocks in the PEO-PPO-PEO TBP, which is the target parameter, W %_{PEO} is the percentage of the total weight of the TBP that is made up of the PEO blocks, and wt %_{PPO} is the percentage of the total weight of the TBP that is made up of the PPO block. In an example, the value of W_{PEO} for the PEO-PPO-PEO TBP that is used as the surfactant is from about 0.2 to about 0.8, with the upper end of the range (e.g., from about 0.6 to about 0.8) being preferred because it tends to give better results as an OER catalyst.

The inventors have also found that the total molecular weight of the surfactant compound can affect the properties of the resulting Ir-based catalyst particles. In an example, the surfactant compound used as the surfactant has a number average molecular weight of from about 1,000 grams per mol (g/mol) to about 14,600 g/mol, with the upper end of the range being preferred (e.g., from about 10,000 g/m to about 14,600 g/mol) because it tends to give better results as an OER catalyst.

Examples of PEO-PPO-PEO TBPs that have been found to be particularly useful as the surfactant compound in step 106 in order to form an effective OER catalyst include, but are not limited to, poloxamer TBPs, such as those sold under the PLURONIC or KOLLIPHOR trade names by BASF Corp., Florham Park, N.J., USA, or those sold under the SYNPERONIC trade name by Croda Inc., Newark, N.J., USA. In specific examples, the surfactant comprises at least one of PLURONIC L31, PLURONIC L35, PLURONIC L43, PLURONIC P123, PLURONIC P105, PLURONIC F68, PLURONIC F88, PLURONIC F127, PLURONIC F108, or any combination thereof. In an example, the amphiphilic nature of the copolymer at a specified molecular concentration in the aqueous Ir precursor solution dominates the properties of the self-organized micelles, which in turn helps to control the structure of the Ir catalyst particles that will be synthesized by the process 100 of FIG. 2.

In the example shown in FIG. 2, the surfactant is added after the 3d transition metal compound is added to the precursor solution (e.g., step 104 of adding the transition metal to the precursor solution is performed before step 106 where the surfactant is added to the same solution). However, those with skill in the art will appreciate that the order of adding the Ir precursor compound, the 3d transition metal precursor compound, and the surfactant is not important or limiting, and that these three components of the precursor solution can be added in any order that works best for the specific process being performed.

In an example, the aggregation of the surfactant molecules can be at least partially controlled, e.g., at optional step 108, by heating the metal precursor and surfactant mixture to an aggregation temperature between room temperature (e.g., from about 20° C. to about 25° C.) and the boiling point of water (e.g., 100° C.), such as from about 40° C. to about 99° C., for example from about 50° C. to about 98.5° C., such as from about 60° C. to about 95° C. In an example, one or more of the specific surfactants used, the ratio of the surfactant relative to the Ir precursor, and the aggregation temperature are selected to achieve a specified size range for the iridium nitrate and iridium oxide particles that are subsequently formed in step 110 and step 114, respectively (described below). In this way, the final size of the Ir catalyst particles can be controlled, at least to a certain extent, by controlling one or more of these variables during the process 100. In other examples, one or more of these variables can also be modified to modify the final physical structure of the Ir-based catalyst particles that are formed by the process 100. For example, a specified combination of the surfactant used, the ratio of surfactant relative to the Ir precursor, and the aggregation temperature can also control one or more physical properties of the resulting Ir catalyst particles, such as, but not limited to, density, porosity, and rigidity of the Ir catalyst particles.

After the surfactant has been added to the iridium precursor solution and the surfactant has been allowed to aggregate into micelles that can act as a soft template for the formation of the Ir-based catalyst structure, the process 100 includes, at step 110, reacting the Iridium precursor compound of the precursor solution with a nitrate salt of an alkaline metal cation (also referred to as the “alkaline metal nitrate”) to provide a reaction product comprising an iridium nitrate, e.g., Ir(NO₃)₄ (also referred herein as “the Ir nitrate” for brevity). In an example, the alkaline metal nitrate comprises, but is not limited to, lithium nitrate (LiNO₃), sodium nitrate (NaNO₃), potassium nitrate (KNO₃), rubidium nitrate (RbNO₃), cesium nitrate (CsNO₃), or any combination thereof. In an example, the weight ratio of the alkaline metal nitrate relative to the Ir precursor compound in the reaction mixture is from about 5:1 to about 200:1.

In an example, the reaction of the Iridium precursor with the alkaline metal nitrate occurs in the same solution, e.g., by adding the alkaline metal nitrate to the iridium precursor solution formed by steps 102, 104, and 106. In the example of hydrogen hexachloroiridate (IV) (H₂IrCl₆ as the Ir precursor compound and sodium nitrate as the nitrate salt, the reaction of step 110 proceeds according to Reaction [E]:

H₂IrCl₆+6NaNO₃→Ir(NO₃)₄+6NaCl_{(aq)}+2HNO₃ [E]

In an example, the step 108 of heating the solution to an aggregation temperature in order to aggregate into micelles can be performed after the reaction of step 110, e.g., to aggregate in order to achieve a specified size range for the iridium nitrate that will eventually form the Ir oxide compound described below.

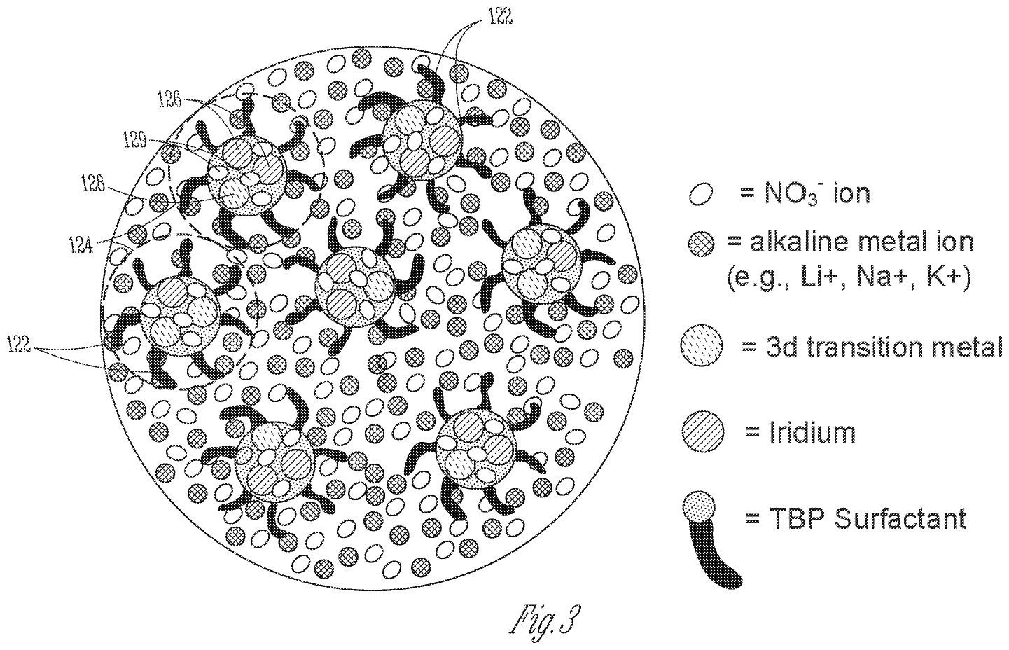

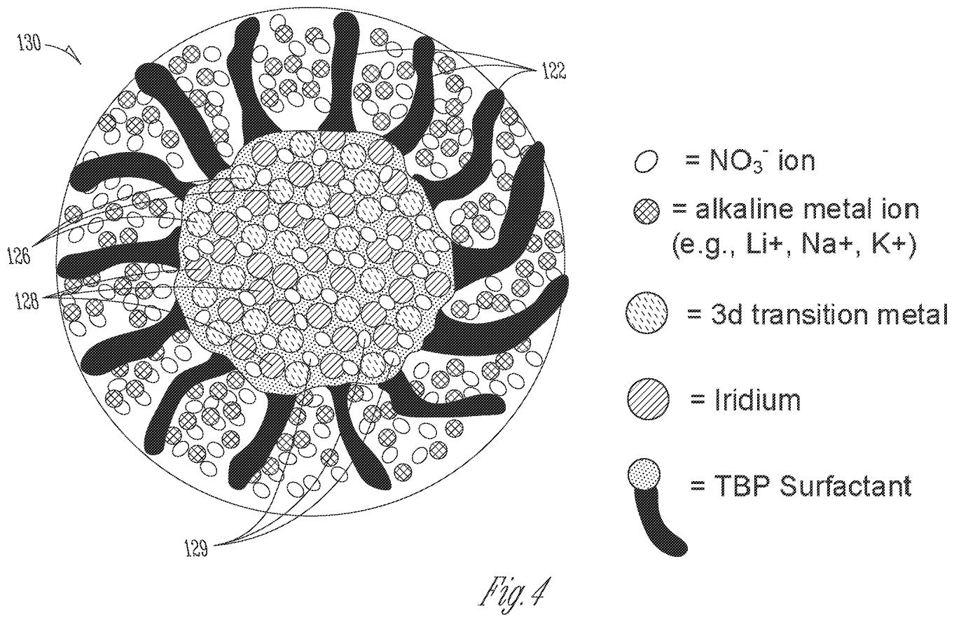

FIG. 3 shows a schematic view of what the inventors theorize occurs in the reaction solution after the reaction of step 110. As shown in FIG. 3, it is believed that a surfactant 122, such as a TBP surfactant as described above, self-aggregates to form small micelles 124 that each surround or substantially surround a small number of molecules of indium 126 or the 3d transition metal dopant 128, or both, along with some of the nitrate ions 129 (NO₃⁻) from Reaction [E]. FIG. 4 shows a schematic view of what the inventors theorize occurs in the reaction solution after heating the reaction mixture such that the surfactant molecules 122 can further aggregate and form a larger micelle 130 (e.g., according to step 108) comprising substantially more iridium 126 and 3d transition metal dopant 128, which can allow for the formation of larger catalyst particles.

The structures shown in FIGS. 3 and 4 are intended to be illustrative of the conceptual principles that occur after the reaction of step 110 and/or the aggregation of step 108, but are not intended to be limiting as far as the actual structures that are formed by the process 100. Those having skill in the art will appreciate that what is shown in FIGS. 3 and 4 are merely a conceptual representation of what the inventors believe occurs during the reaction step 110 and the aggregation step 108.

After reacting the Ir precursor with the alkaline metal nitrate to provide the Ir nitrate solution in step 110, the process 100 can optionally include, at step 112, drying the formed iridium nitrate solution to provide a powder that includes iridium nitrate. The inventors believe that during the drying of step 112, the micelles formed by the surfactant organize the iridium nitrate, which leads to the formation of nano-scale clusters of iridium nitrate with a well-controlled structure, as shown in FIGS. 3 and 4, described above. In some examples, the process can include, after the drying step 112, grinding the iridium nitrate powder to form a fine powder of iridium nitrate (not shown in FIG. 2), e.g., a nitrate powder having a well-controlled structure (such as nano-rods, nanospheres, and the like). The formed structure can strongly depend on the nature of the applied surfactant compound and the alkaline metal nitrate used.

After reacting the Ir precursor and the alkaline metal nitrate in step 110 and drying the Ir nitrate in step 112, the process 100 can include, at step 114, calcining the metal nitrate intermediate in an oxygen and air environment at a specified calcination temperature to convert iridium nitrate intermediate to iridium oxide (IrO₂, also referred to hereinafter as “Ir oxide” for brevity). In an example, the calcination step 114 causes all or substantially all of the surfactant to be decomposed so that the surfactant is essentially removed from the resulting Ir oxide particles.

In an example, calcining the Ir nitrate is performed in an oxygen/air environment at a specified calcination temperature of from about 200° C. to about 600° C. to provide particles of iridium oxide (IrO₂). The specific calcination temperature used can be chosen based on the desired level of crystallization for the final catalyst particles, desired catalyst particle size, and desired porous volume. If the temperature is too low, then the time that the Ir nitrate is being heated may not be sufficient to fully decompose the Ir nitrate to Ir oxide. Also, if the temperature is too low, then there may be residual surfactant that remains on the catalyst particles after calcination. If the temperature is too high, then the particle size may be too large because of sintering and the porous volume of the particles may be too low, resulting in a decrease in catalytic activity of the catalyst for the OER.

In an example, the process 100 of FIG. 2 can optionally include, at step 116, washing the Ir oxide particles with one or more cycles of water, one or more cycles of one or more alcohols, or combinations thereof. In an example, the washing step 116 can include centrifugal separation of the Ir oxide particles from a washing fluid (e.g., water, one or more alcohols, or both), to remove any residual nitrate salt and surfactant, and to form a clean surface on the particles. The process 100 can also optionally include, at step 118, drying the washed Ir oxide particles to provide a dried Ir oxide catalyst particulate product.

The process 100 can also optionally include one or more particle modification procedures to modify the surface of the Ir-based particles. In an example, the particle modification can include, at step 120, acid etching the Ir-based catalyst material (e.g., the Ir oxide that results from step 114, whether it is doped with the 3d transition metal or not) to remove a portion of the surface structure of the Ir-based material particles. In an example, the acid etching of step 120 comprises treating the particles with an aqueous inorganic acid, including, but not limited to, hydrochloric acid (HC), hydrofluoric acid (HF), hydrobromic acid (HBr), sulfuric acid (H₂SO₄, nitric acid (HNO₃), phosphoric acid (H₃PO₄), perchloric acid (HClO₄), and combinations thereof. In an example, the acid used for the acid etching of step 120 has a concentration of from about 0.1 M to about 3 M.

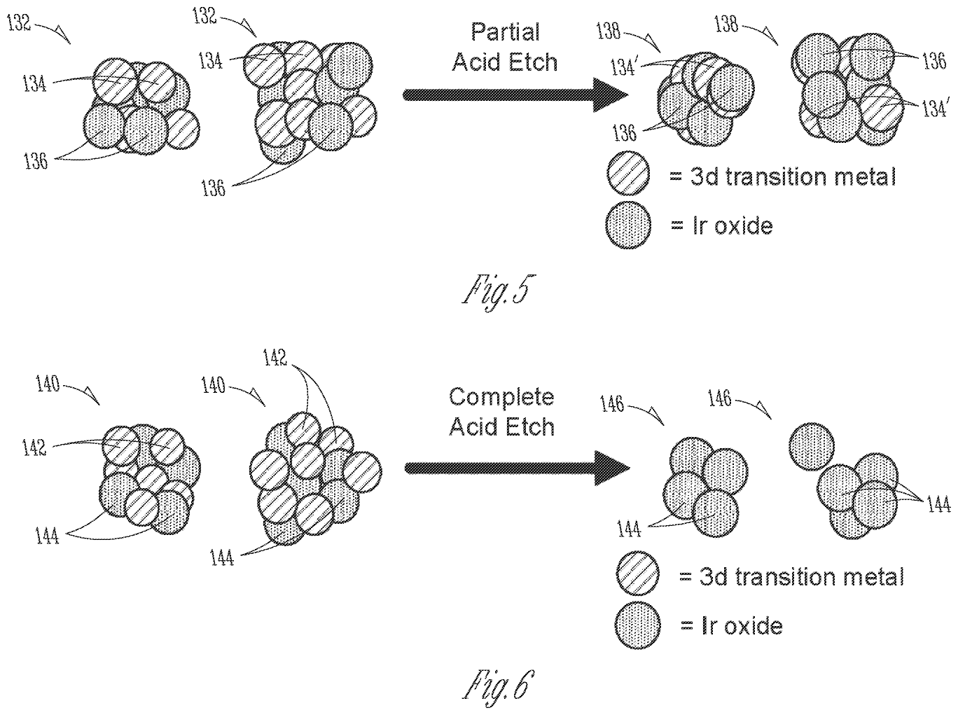

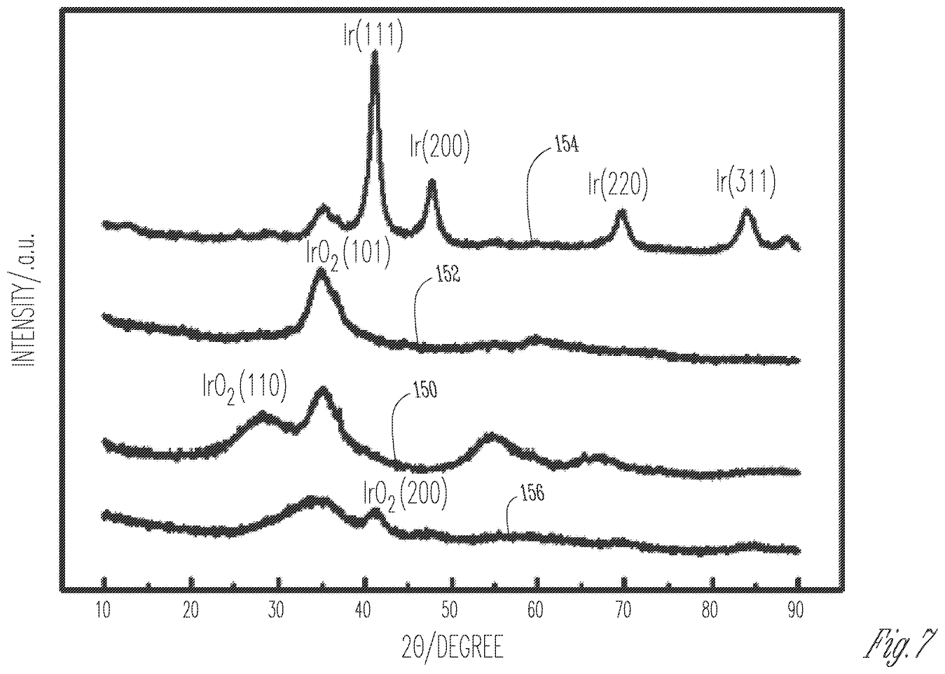

In some examples, the acid etching step 120 can be configured to etch a portion of the 3d transition metal away from the Ir oxide in the catalyst particles, also referred to herein as a partial acid etch. FIG. 6 shows an example of a conceptual effect of a partial acid etching process on nascent catalyst particles 132 that have been formed after step 114 of the process 100. For example, the nascent catalyst particles can be formed into a common catalyst precursor particle 132 because of the surfactant-micelle aggregation of the Ir precursor and the 3d transition metal (steps 102-108) before the reaction to form Ir nitrates (step 110) and then the calcining (step 114) to form the Ir oxide particles 136 interspersed with the 3d transition metal particles 134.

As used herein, the term “nascent catalyst particle” can refer to a particle that includes a catalytic compound of interest, such as the iridium oxide particles 136 in the nascent catalyst particles 132, but which may be further processed either chemically or mechanically to further modify the structure of the nascent catalyst particle. Because the nascent catalyst particles 136 include the catalytic compound of interest, i.e., iridium oxide particles 136, and because active sites on the iridium oxide particles 136 may be accessible to the reactants of the OER, the nascent catalyst particles 132 can be used as a catalyst for the OER. However, in some examples, the nascent catalyst particles 132 may not have as high of a catalytic activity as is desired for a particular OER. In addition, as described above, the OER is often the rate limiting reaction in a solid polymer electrolyte water electrolyzer. For these reasons, it may be desirable to further process the nascent catalyst particles 132, such as with the acid etching step 120.

When the acid etching step 120 comprises partially removing a portion of the 3d transition metal 134 from the nascent catalyst particles 132 but still leaves some of the transition metal 134′ behind to provide final catalyst particles 138. The partial acid etching 120 can increase catalytic activity by, for example, opening up additional active Ir sites on the Ir oxide particles 136 that may have been previously obscured by the portions of 3d transition metal 134 that had been removed.

In other examples, the acid etching of step 120 is configured to remove all or substantially all of the 3d transition metal from the catalyst particles, also referred to herein as a complete acid etch. FIG. 6 shows an example of a conceptual effect of a complete acid etching process on nascent catalyst particles 140. The nascent catalyst particles 140 of the complete acid etch of FIG. 6 can be similar or identical to the nascent catalyst particles 132 for the partial acid etch of FIG. 5, e.g., with 3d transition metal particles 142 interspersed with iridium oxide particles 144. As can be seen in FIG. 6, the complete acid etching removes all or substantially all of the 3d transition metal 142 from the nascent catalyst particles 140 to provide final catalyst particles 146 that comprise no or essentially no transition metal so that the final catalyst particles 146 are formed completely or almost completely from the Ir oxide particles 144. In some examples, the final catalyst particles 146 can also include a small amount of one or more additional materials (not shown), such as a small amount of the 3d transition metal, that hold the iridium oxide particles 144 together in the final catalyst particles 146, for example if the iridium oxide particles 144 do not fuse together by the calcining of step 114.

In some examples, the Ir-based catalyst material formed by the fabrication process 100 of FIG. 2, such as the iridium oxide portions 136, 144 of the catalyst particles 132, 138, 140, 146, have an amorphous structure after the calcination of step 114. As used herein, the term “amorphous.” when referring to the Ir-based catalyst material, means that the Ir-based material has a non-crystalline structure or a structure with poor crystallinity. The inventors have found that amorphous Ir-based particles, such as those formed by the process 100 of FIG. 2, have higher structural flexibility compared to comparable particles made by a similar process that did not use the surfactant 122 (e.g., the process did not include step 106) as a soft template for formation of the iridium nitrate intermediate after step 110 and the iridium oxide catalytic particles after step 115. Similarly, the inventors have found that the amorphous Ir-based catalytic particles formed by the process 100 described herein have more surface defects than the comparable Ir-based particles. Both the structural flexibility and the surface defects contribute to the amorphous particles having a higher efficiency toward the OER than the comparable particles, more stability during electrolysis than the comparable particles, or both.

The fabrication process 100 described herein has several variables that can be modified in order to control certain structural aspects of the catalyst particles. For example, the size of the catalyst particles can be controlled by changing the surfactant being used (e.g., the blocks that make up a TBP surfactant, or the molecular weight of the surfactant), the relative amounts of the surfactant, the iridium precursor, and the 3d transition metal. In some examples, the size of the particles can be controlled within the nanometer scale, e.g., from about 1 nm to about 200 nm. In some examples, the process can provide Ir-based catalyst particles that are from about 5 nm to about 50 nm.

The fabrication process 100 described herein also provides catalyst particles with relatively high porosity and relatively high surface area, which allows for the higher OER activity exhibited by the Ir-based catalyst produced by the fabrication process 100. In an example, the Ir-based catalyst particles produced by the processes 100 can have a surface area of from about 100 square meters per gram (m²g⁻¹) to about 350 m²g⁻¹. In an example, the Ir-based catalyst particles produced by the processes 100 have a well-controlled pore size distribution, for example with pore sizes that are from about 2 nm to about 50 nm.

The structural and chemical features of the Ir-based catalyst described herein have been found to achieve high OER activity, e.g., at 10 mA scm⁻¹ of current density, the overpotential ranges from about 250 V to about 350 V and has long-term stability for the OER. For example, the catalyst produced by the process 100 described herein has been found to maintain greater than about 60% of its activity (e.g., an activity loss of less than 40%) after 2000 cyclic voltammetry (“CV”) cycles at a scan rate of 100 mV s⁻¹ between the potential of about 0.4 V to about 1.4V, for example by maintaining at least about 70% of its activity (e.g., an activity loss of less than 30%) after the 2000 CV cycles.

When used as an electrocatalyst for the OER in a SPEWE, e.g., in either a PEMWE or an AEMWE, the Ir-based catalyst made by the fabrication process 100 described herein can be used as the anode catalyst with a low amount of iridium loading required while still providing for low overpotential in the electrolyzer, and very good long-term stability during the OER. As used herein, the terms “iridium loading” or “catalyst loading” refer to the mass of the indium-based anode catalyst per area of the anode. In an example, the Ir-based catalyst made by the example fabrication process 100 can be effective for the OER with a loading as little as 1.5 milligrams per square centimeter of the anode (mg/cm²) or less, such as 1.25 mg/cm² or less, for example 1.2 mg/cm² or less, such as 1.1 mg/cm² or less, for example 1 mg/cm² or less, such as 0.9 mg/cm² or less, for example 0.8 mg/cm² or less, such as 0.75 mg/cm² or less, for example 0.7 mg/cm² or less, such as 0.6 mg/cm² or less, for example 0.5 mg/cm² or less, such as 0.4 mg/cm² or less, such as 0.3 mg/cm² or less, for example 0.25 mg/cm² or less.

As used herein, the term “overpotential” refers to the potential difference between the actual potential applied across the OER catalyst and the theoretical thermodynamically determine potential, which is 1.23 V. In an example, the OER overpotential across the Ir-based catalysts made by the process 100 described herein is from about 250 millivolt (mV) to about 300 mV of overpotential when a benchmark current density of 10 milliamps per square cm (mA cm⁻²) is applied. This corresponds to from about 80% to about 83% thermodynamic efficiency for the OER catalyst made by the process 100, as compared to around 75% thermodynamic efficiency that is achievable by the best previously made iridium-based catalysts.

Because the fabrication process 100 is based on the conventional Adams fusion process, which has been well known and well developed commercially, the inventors believe that the fabrication process 100 described herein should be readily scalable to a large-scale industrial manufacturing process such that the fabrication process 100 can be used to provide large quantities of Ir-based catalysts (or catalysts based on other transition metals) at relatively high efficiency compared to existing methods of producing these types of catalysts.

### EXAMPLES

Various embodiments of the present invention can be better understood by reference to the following EXAMPLES which are offered by way of illustration. The present invention is not limited to the EXAMPLES given herein.

### Example 1

PLURONIC F127 tri-block polymer surfactant was dissolved in distilled water to form a solution. Metal precursors of H₂IrCl₆.xH₂O (Ir precursor) and CoCl₂.6H₂O (3d transition metal precursor) were added to the solution in a molar ratio of the Ir precursor relative to the 3d transition metal precursor of 4:1, by mol. The molar ratio of total metal (i.e., Ir precursor plus the 3d transition metal precursor) relative to the surfactant was 100:1. The temperature of this precursor solution was maintained at 60° C. while vigorously stirring the solution overnight. The precursor solution was then added dropwise into a saturated potassium nitrate (KNO₃) solution with the same concentration of the surfactant as in the precursor solution. The resulting reaction mixture was allowed to age for twelve (12) hours, and then the aged mixture was carefully heated to a temperature of from about 85° C. to about 95° C. until the solution is dried substantially to completion, resulting in a nitrate powder. The nitrate powder was subsequently ground into a fine powder (e.g., a particle size of from about 50 nm to about 1 μm, such as from about 100 nm to about 500 nm, for example about 200 nm). The ground nitrate powder was calcined in air at 400° C. for two (2) hours to produce particles of a catalyst material comprising Ir oxide doped with cobalt. The catalyst particles were washed with a mixture of distilled water and ethanol and then dried at 40° C. The final dried catalyst of EXAMPLE 1 will be referred to by the shorthand identifier “S100-Ir80Co20” in the discussion below.

### Example 2

A sample of Ir catalyst material was made by the same method as in EXAMPLE 1, but with a molar ratio of the total metal (Ir precursor plus the 3d transition metal precursor) relative to the PLURONIC F127 surfactant of 50:1. The final dried catalyst of EXAMPLE 3 will be referred to by the shorthand identifier “S50-Ir80Co20” in the discussion below.

### Example 3

A sample of Ir catalyst material was made by the same method as in EXAMPLE 1, but with a molar ratio of the total metal (Ir precursor plus the 3d transition metal precursor) relative to the PLURONIC F127 surfactant of 10:1 rather than 100:1 as in EXAMPLE 1. The final dried catalyst of EXAMPLE 2 will be referred to by the shorthand identifier “S10-Ir80Co20” in the discussion below.

### Comparative Example 4

A sample of Ir catalyst material was made by the same method as in EXAMPLE 1, but without using any of the PLURALITY F127 surfactant in the precursor solution to compare the samples from EXAMPLES 1-3 with a reference catalyst made without the surfactant-assisted method of the present disclosure. The final dried reference catalyst of COMPARATIVE EXAMPLE 4 will be referred to by the shorthand identifier “N—Ir80Co20” in the discussion below.

### Comparative Example 5

A sample of Ir catalyst material was made by the same method as in EXAMPLE 1, but without using any of the PLURALITY F127 surfactant or the 3d transition metal compound in the precursor solution to compare the samples from EXAMPLES 1-3 with a reference catalyst made without the 3d transition metal doping or the surfactant-assisted method of the present disclosure. The final dried reference catalyst of COMPARATIVE EXAMPLE 5 will be referred to by the shorthand identifier “N—Ir” in the discussion below.

### Structural Analysis

The structural, chemical, and electronic features of the various Ir80Co20 samples (i.e., the samples of EXAMPLES 1-3 and COMPARATIVE EXAMPLE 4) were examined using the following analytic techniques:
1. The metal content of bulk materials was measured by an Inductively Coupled Plasma (ICP) Optical Emission Spectrometer (Perkin-Elmer Optima 5300 DV, USA);
2. The metal content at the catalyst surface was measured by an X-ray photoelectron spectroscopy (XPS, ESCALAB 250Xi, ThermoFisher Scientific, Waltham, Mass., USA) with a Mg anode as the X-ray source;
3. To detect the porous structure, nitrogen adsorption isotherms were conducted using an Autosorb-1-C (Quantachrome Instruments, Boynton Beach, Fla., USA) at 77 K. Prior to adsorption, samples were degassed in a vacuum at 200° C. for two (2) hours;
4. The Brunauer-Emmett-Teller (BET) method was used to estimate the specific surface area (SBET), which was performed using an Autosorb-1-C (Quantachrome Instruments, Boynton Beach, Fla., USA); and
5. The total pore volume (Vₜₒₜₐₗ) and mean pore size were assessed from the adsorption point at 0.99 p/p₀ by applying the Barrett-Joyner-Halenda (BJH) mode.

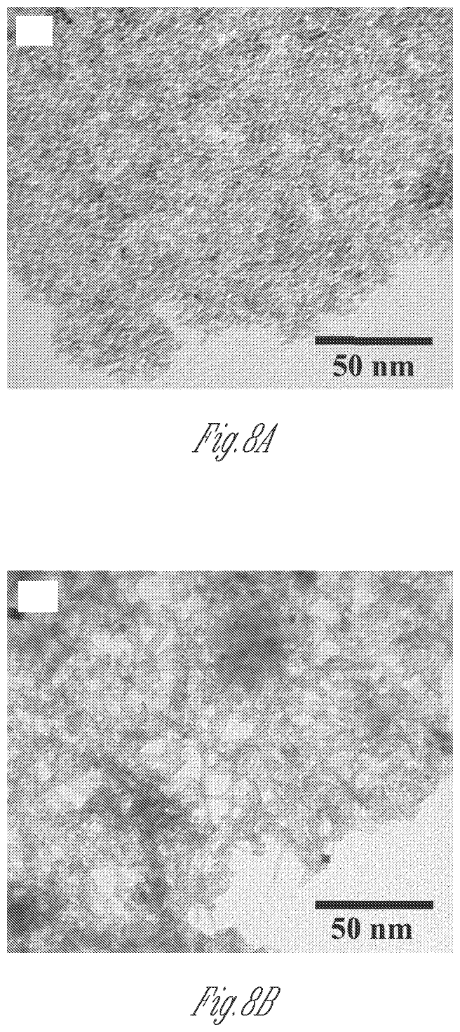

Powder X-ray diffraction (“XRD”) patterns of samples from the EXAMPLES described above were taken using a PANalytical X'Pert PRO (Malvern Panalytical B.V., Almelo, The Netherlands) with a Co radiation (Δ=1.7902 Å) operated at 40 kV and 40 mA. FIG. 7 is a graph of the XRD patterns of the S100-Ir80Co20 sample of EXAMPLE 1 (data series 150), the S50-Ir80Co20 sample of EXAMPLE 2 (data series 152), the S10-Ir80Co20 sample of EXAMPLE 3 (data series 154), and the N—Ir80Co20 sample of COMPARATIVE EXAMPLE 4 (data series 156). The XRD patterns in FIG. 7 show a typical amorphous structure for the samples made via the surfactant-assisted method (i.e., the samples from EXAMPLES 1-3, data series 150, 152, and 154, respectively). In addition, the S50-Ir80Co20 sample (EXAMPLE 2, data series 152) exhibited the IrO₂(1 0 1) structure, which can be preferred for OER catalysis. As can be seen in FIG. 7, no cobalt metal or oxide phase was observed in the XRD patterns, but the inventors believe this is due to the overwhelming signal from the heavier metal iridium and the amorphous and Ir-enriched structure.

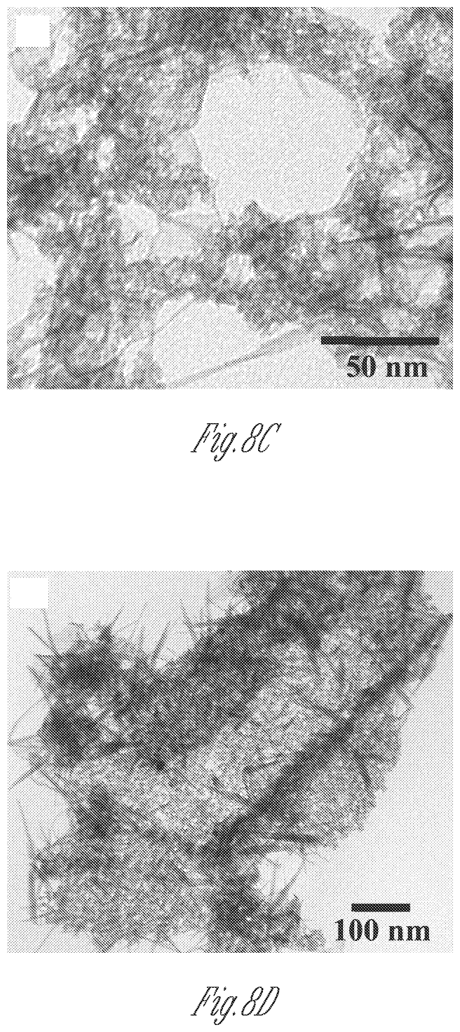

Transmission electron microscopy (“TEM”) images of several samples described above were taken using the JEM-2000EX (JEOL USA, Inc., Peabody, Mass., USA) at 120 kV. TEM images of the N—Ir80Co20 sample (COMPARATIVE EXAMPLE 4), the S100-Ir80Co20 sample (EXAMPLE 1), the S50-Ir80Co20 sample (EXAMPLE 2), and the S10-Ir80Co20 sample (EXAMPLE 3) are shown in FIGS. 1A, 8B, 8C, and 8D, respectively. As shown in FIGS. 8A-8D, the TEM images confirm that the relative amount of surfactant used in the precursor solution has a significant effect on the structure of the resulting Ir-based catalyst. The N—Ir80Co20 sample (COMPARATIVE EXAMPLE 4), which was synthesized without surfactant, has extensive agglomeration to the extent that it almost appears to be a single particle, as seen in FIG. 8A. The surfactant-assisted samples exhibit the formation of rod-like shapes that steadily grow as the relative amount of the TBP surfactant increases, as can be seen by a comparison of FIGS. 8B, 8C, and 8D.

Table 1, below, lists other structural properties of the catalyst particles that may be relevant to OER catalysis in an SPEWE. In Table 1, Ir/(Ir+Co) (ICP) is the bulk % of iridium, on a molar basis, in the catalyst particles as measured by ICP; Ir/(Ir+Co) (XPS) is the % of the surface area at the particle surface that is indium as measured by XPS; S_{BET} is the specific surface area as measured by the BET method; Vₜₒₜₐₗ is the total pore volume per gram of the catalyst as assessed from the adsorption point at 0.99 p/p₀ by applying the BJH mode; and pore size is the average size of the pores in the catalyst particles, which was determined via the low-temperature nitrogen adsorption isotherm method.

TABLE 1
Structural Properties of the Ir-
based catalyst prepared in EXAMPLES

| | | | | | Pore |
|---|---|---|---|---|---|
| | Ir/(Ir + Co) | Ir/(Ir + Co) | S_{BET} | Vₜₒₜₐₗ | size |
| Sample | (ICP) | (XPS) | (m²g⁻¹) | (cm³g⁻¹) | (nm) |
| EXAMPLE 1 | 0.77 | 0.91 | 195.9 | 0.418 | 3.5 |
| (S100- | | | | | |
| Ir80Co20) | | | | | |
| EXAMPLE 2 | 0.78 | 0.91 | 164.0 | 0.389 | 3.5 |
| (S50-Ir80Co20) | | | | | |
| EXAMPLE 3 | 0.79 | 0.86 | 83.4 | 0.339 | 3.6 |
| (S10-Ir80Co20) | | | | | |
| COMP. EX. 4 | 0.79 | 0.88 | 173.0 | 0.245 | 1.7 |
| (N-Ir80Co20) | | | | | |

The data in Table 1 shows that the Ir—Co catalysts made via the surfactant-assisted process described herein (i.e., the samples from EXAMPLES 1-3) have more iridium-enriched surfaces, a larger surface area, a larger total volume per gram, and a larger pore size than the more conventionally prepared iridium catalyst of COMPARATIVE EXAMPLE 4. The data also suggests that the Ir—Co catalyst made via the surfactant-assisted process described here has a mesoporous volume. As used herein, the term “mesoporous” refers to a material having pores having a size of at least about 2 nanometers and up to about 50 nanometers, as defined by the International Union of Pure and Applied Chemistry (‘IUPAC’).

### Oxygen Evolution Reaction Performance

Prior to electrochemical tests, a thin catalyst film was uniformly deposited onto a clean rotating disk electrode (RDE), 5 mg catalyst from EXAMPLES 1-3 and COMPARATIVE EXAMPLES 4 and 5 in a 54 μL Nafion® solution (5 wt. %, equivalent weight=1000) and 4 mL anhydrous ethanol (295%, Sigma-Aldrich) were used to prepare inks. The ink mixtures were placed in a water-filled ultrasonic bath for 30 minutes to uniformly disperse the catalyst particles. Each resulting ink was then deposited onto the entire surface of the disk electrode. The coating/drying cycles were cameo out several times until a target loading of about 0.1 mg cm⁻² was reached.

The thin film coated RDEs were used as part of the working electrode in several electrochemical cells, defined as EXAMPLES 6-8 and COMPARATIVE EXAMPLES 9 and 10. Each electrochemical cell contained N₂-purged 0.5 M H₂SO₄ with a reference electrode and counter electrode.

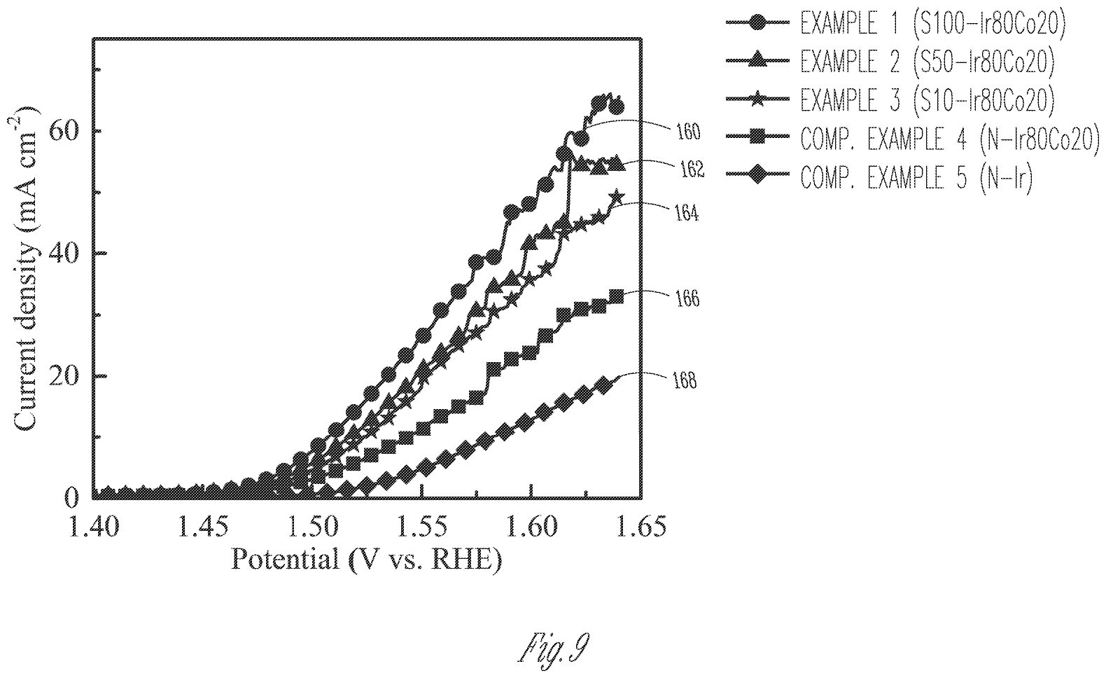

Configurations of the working electrode that were tested include a flow cell and a rotating disc electrode. Linear sweep voltammetry (“LSV”) testing at 2 mV s⁻¹ was performed to assess catalytic activity for OER for the electrochemical cells using the catalyst samples of EXAMPLES 1-3 and COMPARATIVE EXAMPLES 4 and 5. FIG. 9 shows the results of the LSV testing. As can be seen in FIG. 9, the electrochemical cell using the S100-Ir80Co20 sample from EXAMPLE 1 (data series 160) obtained the highest OER activity in all tested samples, which is comparable to the most effective catalysts that have been reported, except that the electrochemical cell of EXAMPLE 1 was able to achieve this activity with less catalyst loading than in those catalyst reported in the prior art. FIG. 9 also includes data for electrochemical cells using (in order of decreasing catalytic activity) the S50-Ir80Co20 sample from EXAMPLE 2 (data series 162), the S10-Ir80Co20 sample of EXAMPLE 3 (data series 164), the N—Ir80Co20 sample of COMPARATIVE EXAMPLE 4 (data series 166), and the N—Ir sample of COMPARATIVE EXAMPLE 5 (data series 168).

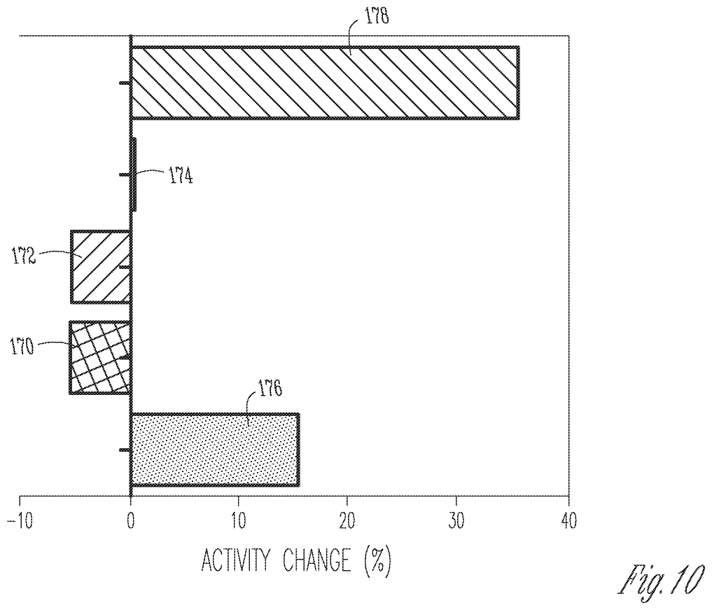

Repetitive cyclic voltammetry (“CV”) tests were performed on each of the electrochemical cells at 100 mV s⁻¹ at from 0.4 V to 1.4 V, and durability performances were evaluated through changes in the LSV curves after the 2000 cycles of CV. FIG. 10 is a bar graph showing the change between the initial OER activity for each electrochemical cell and the OER activity after the 2000 CV cycles. As shown in FIG. 10, essentially no activity loss was observed in the electrochemical cells using the S100-Ir80Co20 catalyst from EXAMPLE 1 (data bar 170) and the S50-Ir80Co20 catalyst from EXAMPLE 2 (data bar 172), and there was very little loss in activity for the cell using the S10-Ir80Co20 catalyst from EXAMPLE 3 (data bar 174). This is in comparison to the electrochemical cell with an Ir-based catalyst doped with transition metal Co but made by conventional Adams fusion with no surfactant from COMPARATIVE EXAMPLE 4 (data bar 176), which had a loss in activity of just over 15% and to the electrochemical cell of with an Ir-based catalyst made by conventional Adams fusion with no surfactant and no transition metal doping from COMPARATIVE EXAMPLE 5 (data bar 178), which had a loss in activity of more than 35% The S100-Ir80Co20 catalyst of EXAMPLE 1 demonstrates that an Ir-based catalyst that is fabricated by the process described herein provides for outstanding activity (as evidenced by data series 160 in FIG. 9) and stability (as evidenced by data bar 170 in FIG. 10) when compared to Ir-based catalysts made by more conventional methods (e.g., data series 166 and 168 in FIG. 9 and data bars 176 and 178 in FIG. 10 for COMPARATIVE EXAMPLES 4 and 5, respectively). Moreover, the other Ir-based catalysts made by the process 100 described herein (i.e., the S50-Ir80Co20 of EXAMPLE 2 and the S10-Ir80Co20 of EXAMPLE 3) also exhibited improved activity (as evidenced by data series 162 and 164 in FIG. 9) and durability (as evidenced by data bars 172 and 174) compared to the reference catalyst samples that were made by conventional methods (as shown by data series 166 and 168 in FIG. 9 and data bars 176 and 178 in FIG. 10 for COMPARATIVE EXAMPLES 4 and 5, respectively).

### Examples 6 and 7—Effect of Nitrate Salt on Catalyst Structure

Two additional samples of Ir catalyst material was made by the same method as in EXAMPLE 1, but by adding a nitrate salt to the precursor solution different from the potassium nitrate (KNO₃) that was used in EXAMPLE 1. For EXAMPLE 6, sodium nitrate (NaNO₃) was added to the precursor solution rather than potassium nitrate (KNO₃). For EXAMPLE 7, lithium nitrate (LiNO₃) was used in place of potassium nitrate (KNO₃). The catalysts made in EXAMPLE 1, EXAMPLE 6, and EXAMPLE 7 will also be referred to by the shorthand identifiers “Ir80Co20_K,” “Ir80Co20_Na.” and “Ir80Co20_Li,” respectively in the discussion below.

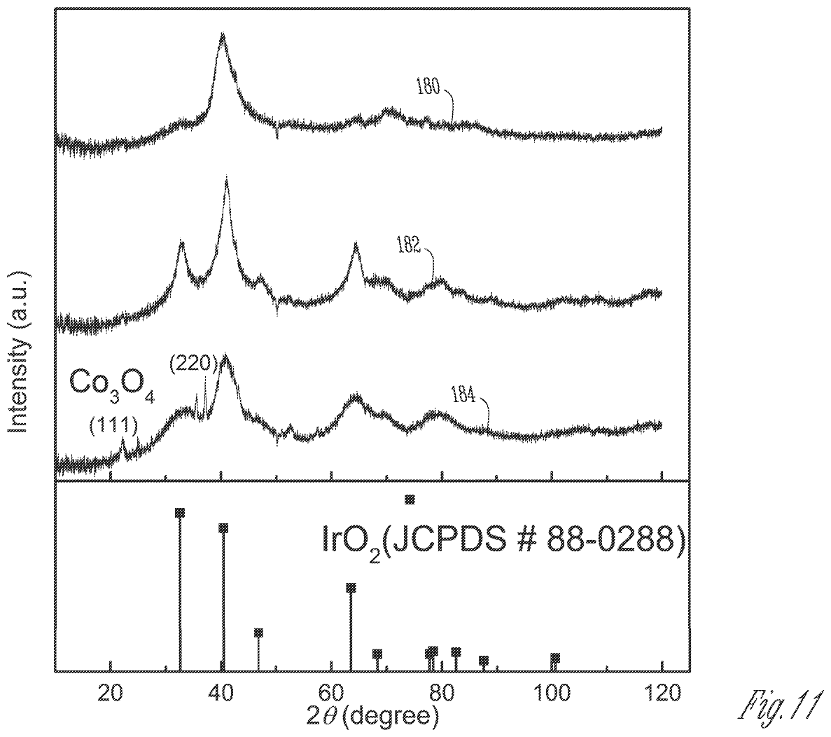

The XRD patterns of each of the catalyst made using different nitrate salts are shown in FIG. 11. The XRD patterns show that the structure of Ir—Co oxide may strongly depend on the specific nitrate salt that is used during the process. Only the Ir80Co20_K sample that was made using KNO₃ from EXAMPLE 1 (data series 180) resulted in an amorphous structure, while the Ir80Co20_Na sample of EXAMPLE 6 (data series 182) and the Ir80Co20_Li sample of EXAMPLE 7 (data series 184) showed peaks corresponding to a crystalline structure.

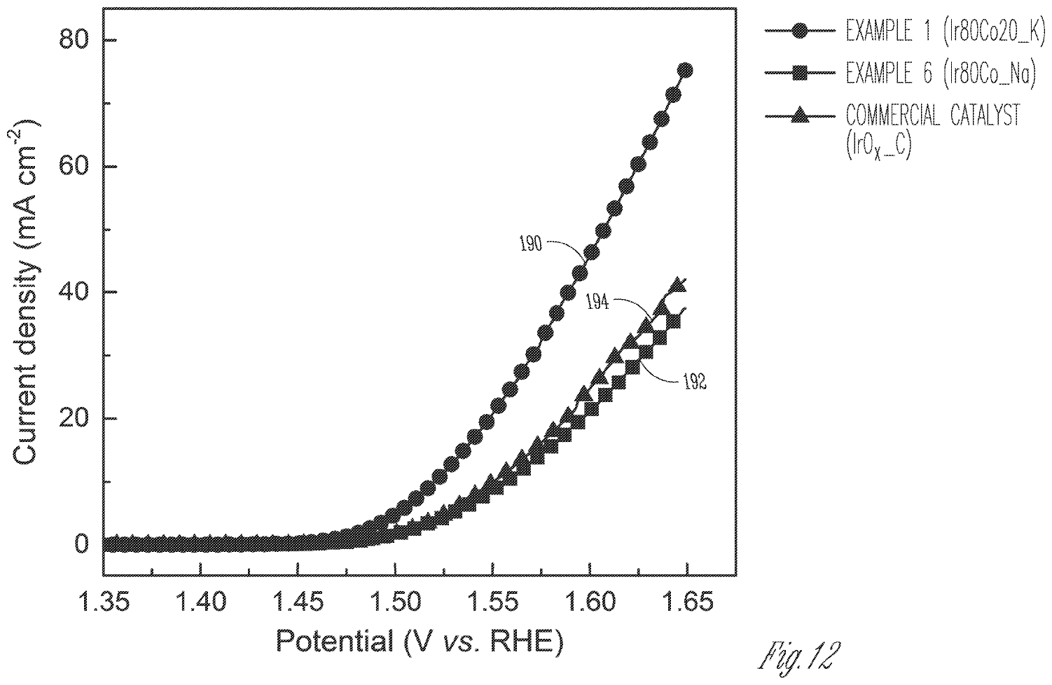

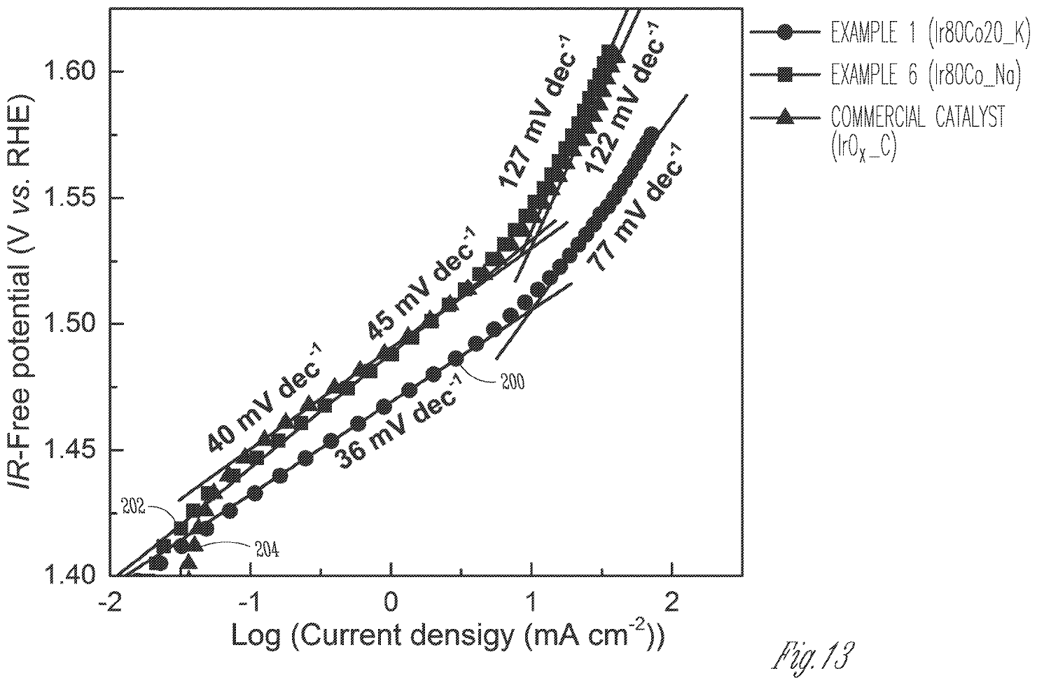

The OER activity of the Ir80Co20_K catalyst (EXAMPLE 1) and the Ir80Co10_Na catalyst (EXAMPLE 6) was measured by using the method described above with respect to FIG. 9, but the electrolyte was changed to N₂-saturated 1 M KOH rather than the N₂-purged 0.5 M H₂SO₄. The OER activity was also tested for a commercially available Ir oxide catalyst (99.99% metals basis, Premion™, Alfa Aesar Tewksbury, Mass., USA, catalog No. AA4339603), which is referred to by the shorthand identifier “IrOₓ_C.” FIG. 12 shows the activity results, with data series 190 showing the data for the Ir80Co20_K sample of EXAMPLE 1, data series 192 corresponding to the data for Ir80Co20_Na sample of EXAMPLE 6, and data series 194 corresponding to the data for the commercially available IrOₓ_C catalyst. FIG. 13 shows ohmic-corrected Tafel plots of catalyst activity for the Ir80Co20_K sample of EXAMPLE 1 (data series 200), for the Ir80Co20_Na of EXAMPLE 6 (data series 202), and for the commercially available IrOₓ_C catalyst (data series 204).

As can be seen in FIGS. 12 and 13, the amorphous Ir80Co20_K obtained higher activity and lower mass transport resistance, even when compared to the commercially available Ir oxide (IrOₓ_C). The inventors believe that this is due to the Ir80Co20_K catalyst having structural flexibility and enhanced surface defects compared to the commercially available catalyst.

To better illustrate the apparatuses and methods disclosed herein, a non-limiting list of exemplary EMBODIMENTS is provided here:

EMBODIMENT 1 can include subject matter (such as an apparatus, a device, a method, or one or more means for performing acts), such as can include a method of fabricating a catalyst material, the method comprising (a) forming or receiving a precursor solution of an iridium precursor compound, (b) adding a 3d orbital transition metal compound to the precursor solution, (c) adding a surfactant compound to the precursor solution to provide a precursor and surfactant mixture, (d) adding a nitrate salt of an alkaline metal cation to the precursor and surfactant mixture so that the iridium precursor compound reacts with the nitrate salt of the alkaline metal cation to provide a reaction product comprising an iridium nitrate, and (e) calcining the iridium nitrate at a specified calcination temperature to convert the iridium nitrate to form catalyst particles comprising iridium oxide.

EMBODIMENT 2 can include or can optionally be combined with the subject matter of EMBODIMENT 1, to optionally include the iridium precursor compound comprising at least one of a hydrogen haloiridate, a substituted hydrogen hexahaliridate, an inorganic iridium containing compound, a soluble iridium containing organic compound; and combinations thereof.

EMBODIMENT 3 can include or can optionally be combined with the subject matter of one or any combination of EMBODIMENTS 1 and 2, to optionally include the iridium precursor compound comprising at least one of: hydrogen hexachloroiridate (H₂IrCl₆); hydrogen hexabromoiridate (H₂IrBr₆); potassium hexachloroiridate (K₂IrCl₆); sodium hexachloroiridate (Na₂IrCl₆); cesium hexachloroiridate (Cs₂IrCl₂); iridium chloride (IrCl₃); iridium nitrate (Ir(NO₃)₃); iridium (III) acetylacetonate; bis(1,5-cyclooctadiene)iridium(I) tetrafluoroborate; chloro(1,5-cyclooctadiene)iridium(I) dimer; methoxy(1,5-cyclooctadiene)iridium(I) dimer; and combinations thereof.

EMBODIMENT 4 can include or can optionally be combined with the subject matter of one or any combination of EMBODIMENTS 1-3, to optionally include the 3d orbital transition metal compound comprising a transition metal in Period 4 of the periodic table.

EMBODIMENT 5 can include or can optionally be combined with the subject matter of one or any combination of EMBODIMENTS 1-4, to optionally include the 3d orbital transition metal compound comprising a transition metal having an atomic number from 21 to 31.

EMBODIMENT 6 can include or can optionally be combined with the subject matter of one or any combination of EMBODIMENTS 1-5, to optionally include the 3d orbital transition metal compound comprising at least one of scandium (Sc), titanium (Ti), vanadium (V), chromium (Cr), manganese (Mn), iron (Fe), cobalt (Co), nickel (Ni), copper (Cu), and zinc (Zn).

EMBODIMENT 7 can include or can optionally be combined with the subject matter of one or any combination of EMBODIMENTS 1-4, to optionally include the catalyst particles resulting from step (e) comprising a doped iridium oxide having the formula

IrₓM₁₋ₓO_{y}

wherein x is a number more than 0 and less than 1, M is a 3d orbital transition metal from the 3d orbital transition metal compound, and y is a number less than 2.

EMBODIMENT 8 can include or can optionally be combined with the subject matter of one or any combination of EMBODIMENTS 1-7, to optionally include the surfactant compound in step (c) comprising an amphiphilic compound.

EMBODIMENT 9 can include or can optionally be combined with the subject matter of one or any combination of EMBODIMENTS 1-8, to optionally include the surfactant compound in step (c) having a hydrophilic end group and a hydrophobic body group.

EMBODIMENT 10 can include or can optionally be combined with the subject matter of one or any combination of EMBODIMENTS 1-9, to optionally include the surfactant compound in step (c) comprising a nonionic triblock copolymer with a polymer chain comprising hydrophilic end blocks at ends of the polymer chain and a hydrophobic block between the hydrophilic end blocks.

EMBODIMENT 11 can include or can optionally be combined with the subject matter of one or any combination of EMBODIMENTS 1-10, to optionally include the surfactant compound in step (c) comprising a triblock polymer with a polymer chain comprising poly(ethylene oxide) blocks at ends of the polymer chain and a poly(propylene oxide) block between the poly(ethylene oxide) end blocks.

EMBODIMENT 12 can include or can optionally be combined with the subject matter of EMBODIMENTS 11, to optionally include a relative weight of the poly(ethylene oxide) blocks being defined by the formula:

$${W}_{PEO} = \frac{wt {\%}_{PEO}}{wt {\%}_{PEO} + wt {\%}_{PPO}}$$

wherein wt %_{PEO} is the weight percentage of the poly(ethylene oxide) blocks in the triblock polymer and wt %_{PPO} is the weight percentage of the poly(propylene oxide) block in the triblock polymer, wherein W_{PEO} is from about 0.2 to about 0.8.

EMBODIMENT 13 can include or can optionally be combined with the subject matter of EMBODIMENT 12, to optionally include W_{PEO} being from about 0.6 to about 0.8.

EMBODIMENT 14 can include or can optionally be combined with the subject matter of one or any combination of EMBODIMENTS 1-13, to optionally include the surfactant compound having a number average molecular weight of from about 2,000 grams per mol to about 14,600 grams per mol.

EMBODIMENT 15 can include or can optionally be combined with the subject matter of one or any combination of EMBODIMENTS 1-14, to optionally include the surfactant compound having a number average molecular weight of from about 10,000 grams per mol to about 14,600 grams per mol.

EMBODIMENT 16 can include or can optionally be combined with the subject matter of one or any combination of EMBODIMENTS 1-15, to optionally include a molar ratio of the surfactant compound relative to the combined concentration of iridium and 3d orbital transition metal in the precursor and surfactant mixture being from about 0.001 to about 0.5.

EMBODIMENT 17 can include or can optionally be combined with the subject matter of one or any combination of EMBODIMENTS 1-16, to optionally include after step (c), (f) heating the metal precursor and surfactant mixture to an aggregation temperature.

EMBODIMENT 18 can include or can optionally be combined with the subject matter of EMBODIMENT 17, to optionally include the heating of step (f) resulting in the formation of aggregated micelles of iridium, 3d orbital transition metal, and the surfactant compound.

EMBODIMENT 19 can include or can optionally be combined with the subject matter of one or any combination of EMBODIMENTS 1-18, to optionally include the aggregation temperature in step (f) being from about 20° C. to about 100° C.

EMBODIMENT 20 can include or can optionally be combined with the subject matter of one or any combination of EMBODIMENTS 1-19, to optionally include the aggregation temperature of step (f) being from about 40° C. to about 99° C.

EMBODIMENT 21 can include or can optionally be combined with the subject matter of one or any combination of EMBODIMENTS 1-20, to optionally include the nitrate salt of the alkaline metal cation of step (d) comprising at least one of lithium nitrate (LiNO₃), sodium nitrate (NaNO₃), potassium nitrate (KNO₃), rubidium nitrate (RbNO₃), and cesium nitrate (CsNO₃).

EMBODIMENT 22 can include or can optionally be combined with the subject matter of one or any combination of EMBODIMENTS 1-21, to optionally include a weight ratio of the nitrate salt of the alkaline metal cation relative to the iridium precursor compound reacted in step (d) being from about 5:1 to about 200:1.

EMBODIMENT 23 can include or can optionally be combined with the subject matter of one or any combination of EMBODIMENTS 1-22, to optionally include step (d) resulting in an intermediate iridium nitrate solution, the method further comprising, before step (e), (g) drying the intermediate iridium nitrate solution to provide a powder that includes iridium nitrate.

EMBODIMENT 24 can include or can optionally be combined with the subject matter of EMBODIMENT 23, to optionally include the drying of step (g) being performed at a drying temperature of from about 40° C. to about 99° C.

EMBODIMENT 25 can include or can optionally be combined with the subject matter of one or any combination of EMBODIMENTS 1-25, to optionally include the calcination temperature in step (e) being from about 200° C. to about 600° C.

EMBODIMENT 26 can include or can optionally be combined with the subject matter of one or any combination of EMBODIMENTS 1-25, to optionally include: (h) washing the catalyst particles with one or more cycles of water, one or more alcohols, or a combination thereof to provide washed catalyst particles.

EMBODIMENT 27 can include or can optionally be combined with the subject matter of EMBODIMENT 26, to optionally include cooling the catalyst particles to room temperature before step (h).

EMBODIMENT 28 can include or can optionally be combined with the subject matter of one or both of EMBODIMENT 26 and EMBODIMENT 27, to optionally include step (h) comprising centrifugal separation of the washed catalyst particles from the water, the one or more alcohols, or the combination thereof.

EMBODIMENT 29 can include or can optionally be combined with the subject matter of one or any combination of EMBODIMENTS 26-28, to optionally include drying the washed catalyst particles.

EMBODIMENT 30 can include or can optionally be combined with the subject matter of one or any combination of EMBODIMENTS 1-29, to optionally include: (i) acid-etching the catalyst particles.

EMBODIMENT 31 can include or can optionally be combined with the subject matter of EMBODIMENT 30, to optionally include the acid-etching of step (i) removing at least a portion of the 3d orbital transition metal away from the iridium oxide in the catalyst particles.

EMBODIMENT 32 can include or can optionally be combined with the subject matter of one or both EMBODIMENT 30 and EMBODIMENT 31, to optionally include the acid etching of step (i) comprising treating the catalyst particles with hydrochloric acid (HC), hydrofluoric acid (HF), hydrobromic acid (HBr), sulfuric acid (H₂SO₄), nitric acid (HNO₃), phosphoric acid (H₃PO₄), perchloric acid (HClO₄), or a combination thereof.

EMBODIMENT 33 can include or can optionally be combined with the subject matter of one or any combination of EMBODIMENTS 1-32, to optionally include after step (c), allowing the surfactant compound to aggregate into micelles comprising a plurality of molecules of the surfactant compound at least partially surrounding a portion of the iridium precursor compound and a portion of the 3d orbital transition metal.

EMBODIMENT 34 can include, or can optionally be combined with the subject matter of one or any combination of EMBODIMENTS 1-33, to include subject matter (such as an apparatus, a device, a method, or one or more means for performing acts), such as can include a method of fabricating a catalyst material, the method comprising: (a) forming or receiving a precursor solution of an iridium precursor compound, (b) adding a 3d orbital transition metal compound to the precursor solution, (c) adding a surfactant compound to the precursor solution to provide a precursor and surfactant mixture, (d) heating the metal precursor and surfactant mixture to an aggregation temperature of from about 20° C. to about 100° C. to form micelles comprising the iridium precursor compound and the 3d orbital transition metal at least partially surrounded by the surfactant compound, (e) adding a nitrate salt of an alkaline metal cations to the precursor and surfactant mixture so that the iridium precursor compound reacts with the nitrate salt of the alkaline metal cation to provide a reaction product comprising an iridium nitrate, and (f) calcining the iridium nitrate at a specified calcination temperature to convert the iridium nitrate to form catalyst particles comprising an iridium oxide.

EMBODIMENT 35 can include or can optionally be combined with the subject matter of EMBODIMENT 34, to optionally include the aggregation temperature of step (d) being from about 40° C. to about 99° C.

EMBODIMENT 36 can include or can optionally be combined with the subject matter of one or any combination of EMBODIMENT 34 and EMBODIMENT 35, to optionally include the iridium precursor compound comprising at least one of a hydrogen haloiridate, a substituted hydrogen hexahaliridate, an inorganic iridium containing compound, a soluble iridium containing organic compound; and combinations thereof.

EMBODIMENT 37 can include or can optionally be combined with the subject matter of one or any combination of EMBODIMENTS 34-36, to optionally include the iridium precursor compound comprising at least one of: hydrogen hexachloroiridate (H₂IrCl₆); hydrogen hexabromoiridate (H₂IrBr₆); potassium hexachloroiridate (K₂IrCl₆); sodium hexachloroiridate (Na₂IrCl₆); cesium hexachloroiridate (Cs₂IrCl₆); indium chloride (IrCl₃); iridium nitrate (Ir(NO₃)₃); iridium (III) acetylacetonate; bis(1,5-cyclooctadiene)iridium(I) tetrafluoroborate; chloro(1,5-cyclooctadiene)iridium(I) dimer; methoxy(1,5-cyclooctadiene)iridium(I) dimer; and combinations thereof.

EMBODIMENT 38 can include or can optionally be combined with the subject matter of one or any combination of EMBODIMENTS 34-37, to optionally include the 3d orbital transition metal compound comprising a transition metal in Period 4 of the periodic table.

EMBODIMENT 39 can include or can optionally be combined with the subject matter of one or any combination of EMBODIMENTS 34-38, to optionally include the 3d orbital transition metal compound comprising a transition metal having an atomic number from 21 to 31.

EMBODIMENT 40 can include or can optionally be combined with the subject matter of one or any combination of EMBODIMENTS 34-39, to optionally include the 3d orbital transition metal compound comprising at least one of scandium (Sc), titanium (Ti), vanadium (V), chromium (Cr), manganese (Mn), iron (Fe), cobalt (Co), nickel (Ni), copper (Cu), and zinc (Zn).

EMBODIMENT 41 can include or can optionally be combined with the subject matter of one or any combination of EMBODIMENTS 34-40, to optionally include the catalyst particles resulting from step (t) comprising a doped iridium oxide having the formula:

IrₓM₁₋ₓO_{y}

wherein x is a number more than 0 and less than 1, M is a 3d orbital transition metal from the 3d orbital transition metal compound, and y is a number less than 2.

EMBODIMENT 42 can include or can optionally be combined with the subject matter of one or any combination of EMBODIMENTS 34-41, to optionally include the surfactant compound in step (c) comprising an amphiphilic compound.

EMBODIMENT 43 can include or can optionally be combined with the subject matter of EMBODIMENT 42, to optionally include the surfactant compound in step (c) having a hydrophilic end group and a hydrophobic body group.

EMBODIMENT 44 can include or can optionally be combined with the subject matter of one or any combination of EMBODIMENTS 34-43, to optionally include the surfactant compound in step (c) comprising a nonionic triblock copolymer with a polymer chain comprising hydrophilic end blocks at ends of the polymer chain and a hydrophobic block between the hydrophilic end blocks.

EMBODIMENT 45 can include or can optionally be combined with the subject matter of one or any combination of EMBODIMENTS 34-44, to optionally include the surfactant compound in step (c) comprising a triblock polymer with a polymer chain comprising poly(ethylene oxide) blocks at ends of the polymer chain and a poly(propylene oxide) block between the poly(ethylene oxide) end blocks.

EMBODIMENT 46 can include or can optionally be combined with the subject matter of EMBODIMENT 45, to optionally include a relative weight of the poly(ethylene oxide) blocks being defined by the formula:

$${W}_{PEO} = \frac{wt {\%}_{PEO}}{wt {\%}_{PEO} + wt {\%}_{PPO}}$$

wherein wt %_{PEO} is the weight percentage of the poly(ethylene oxide) blocks in the triblock polymer and wt %_{PPO} is the weight percentage of the poly(propylene oxide) block in the triblock polymer, wherein W_{PEO} is from about 0.2 to about 0.8.

EMBODIMENT 47 can include or can optionally be combined with the subject matter of EMBODIMENT 46, to optionally include W_{PEO} being from about 0.6 to about 0.8.

EMBODIMENT 48 can include or can optionally be combined with the subject matter of one or any combination of EMBODIMENTS 34-47, to optionally include the surfactant compound having a number average molecular weight of from about 2,000 grams per mol to about 14.600 grams per mol.

EMBODIMENT 49 can include or can optionally be combined with the subject matter of one or any combination of EMBODIMENTS 34-48, to optionally include the surfactant compound having a number average molecular weight of from about 10,000 grams per mol to about 14.600 grams per mol.

EMBODIMENT 50 can include or can optionally be combined with the subject matter of one or any combination of EMBODIMENTS 34-49, to optionally include a molar ratio of the surfactant compound relative to the combined concentration of iridium and 3d orbital transition metal in the precursor and surfactant mixture being from about 0.001 to about 0.5.

EMBODIMENT 51 can include or can optionally be combined with the subject matter of one or any combination of EMBODIMENTS 34-50, to optionally include the nitrate salt of the alkaline metal cation of step (e) comprising at least one of lithium nitrate (LiNO₃), sodium nitrate (NaNO₃), potassium nitrate (KNO₃), rubidium nitrate (RbNO₃), and cesium nitrate (CsNO₃).

EMBODIMENT 52 can include or can optionally be combined with the subject matter of one or any combination of EMBODIMENTS 34-51, to optionally include a weight ratio of the nitrate salt of the alkaline metal cation relative to the iridium precursor compound reacted in step (e) being from about 5:1 to about 200:1.

EMBODIMENT 53 can include or can optionally be combined with the subject matter of one or any combination of EMBODIMENTS 34-52, to optionally include step (e) resulting in an intermediate iridium nitrate solution, the method further comprising, before step (f): (g) drying the intermediate iridium nitrate solution to provide a powder that includes iridium nitrate.

EMBODIMENT 54 can include or can optionally be combined with the subject matter of one or any combination of EMBODIMENTS 34-53, to optionally include the drying of step (g) being performed at a drying temperature of from about 40° C. to about 99° C.

EMBODIMENT 55 can include or can optionally be combined with the subject matter of one or any combination of EMBODIMENTS 34-54, to optionally include the calcination temperature in step (f) being from about 200° C. to about 600° C.

EMBODIMENT 56 can include or can optionally be combined with the subject matter of one or any combination of EMBODIMENTS 34-55, to optionally include: (h) washing the catalyst particles with one or more cycles of water, one or more alcohols, or a combination thereof to provide washed catalyst particles.

EMBODIMENT 57 can include or can optionally be combined with the subject matter of EMBODIMENT 56, to optionally include cooling the catalyst particles to room temperature before step (h).

EMBODIMENT 58 can include or can optionally be combined with the subject matter of one or any combination of EMBODIMENT 56 and EMBODIMENT 57, to optionally include step (h) comprising centrifugal separation of the washed catalyst particles from the water, the one or more alcohols, or the combination thereof.

EMBODIMENT 59 can include or can optionally be combined with the subject matter of one or any combination of EMBODIMENTS 56-58, to optionally include drying the washed catalyst particles.

EMBODIMENT 60 can include or can optionally be combined with the subject matter of one or any combination of EMBODIMENTS 34-59, to optionally include: (i) acid-etching the catalyst particles.

EMBODIMENT 61 can include or can optionally be combined with the subject matter of EMBODIMENT 60, to optionally include the acid-etching of step (i) removing at least a portion of the 3d orbital transition metal away from the iridium oxide in the catalyst particles.

EMBODIMENT 62 can include or can optionally be combined with the subject matter of one or any combination of EMBODIMENT 60 and EMBODIMENT 59, to optionally include the acid etching of step (i) comprising treating the catalyst particles with hydrochloric acid (HCl), hydrofluoric acid (HF), hydrobromic acid (HBr), sulfuric acid (H₂SO₄), nitric acid (HNO₃), phosphoric acid (H₃PO₄), perchloric acid (HClO₄), or a combination thereof.

EMBODIMENT 63 can include or can optionally be combined with the subject matter of one or any combination of EMBODIMENTS 34-62, to optionally include after step (c), allowing the surfactant compound to aggregate into micelles comprising a plurality of molecules of the surfactant compound at least partially surrounding a portion of the iridium precursor compound and a portion of the 3d orbital transition metal.

EMBODIMENT 64 can include, or can optionally be combined with the subject matter of one or any combination of EMBODIMENTS 1-63, to include subject matter (such as an apparatus, a device, a method, or one or more means for performing acts), such as can include a method of fabricating a catalyst material, the method comprising (a) forming or receiving a precursor solution of an iridium precursor compound, (b) adding a 3d orbital transition metal compound to the precursor solution, (c) adding a surfactant compound to the precursor solution to provide a precursor and surfactant mixture, wherein the surfactant compound comprises an amphiphilic compound having one or more hydrophilic groups and one or more hydrophobic groups, (d) adding a nitrate salt of an alkaline metal cation to the precursor and surfactant mixture so that the iridium precursor compound reacts with the nitrate salt of the alkaline metal cation to provide a reaction product comprising iridium nitrate, and (e) calcining the iridium nitrate at a specified calcination temperature to convert the iridium nitrate to form catalyst particles comprising an iridium oxide.

EMBODIMENT 65 can include or can optionally be combined with the subject matter of EMBODIMENT 64, to optionally include the surfactant compound in step (c) having a hydrophilic end group and a hydrophobic body group.

EMBODIMENT 66 can include or can optionally be combined with the subject matter of one or any combination of EMBODIMENT 64 and EMBODIMENT 65, to optionally include the surfactant compound in step (c) comprising a nonionic triblock copolymer with a polymer chain comprising hydrophilic end blocks at ends of the polymer chain and a hydrophobic block between the hydrophilic end blocks.

EMBODIMENT 67 can include or can optionally be combined with the subject matter of one or any combination of EMBODIMENTS 64-6, to optionally include the surfactant compound in step (c) comprising a triblock polymer with a polymer chain comprising poly(ethylene oxide) blocks at ends of the polymer chain and a poly(propylene oxide) block between the poly(ethylene oxide) end blocks.

EMBODIMENT 68 can include or can optionally be combined with the subject matter of EMBODIMENT 67, to optionally include a relative weight of the poly(ethylene oxide) blocks being defined by the formula:

$${W}_{PEO} = \frac{wt {\%}_{PEO}}{wt {\%}_{PEO} + wt {\%}_{PPO}}$$

wherein w %_{PEO} is the weight percentage of the poly(ethylene oxide) blocks in the triblock polymer and wt %_{PPO} is the weight percentage of the poly(propylene oxide) block in the triblock polymer, wherein W_{PEO} is from about 0.2 to about 0.8.

EMBODIMENT 69 can include or can optionally be combined with the subject matter of EMBODIMENT 68, to optionally include W_{PEO} being from about 0.6 to about 0.8.

EMBODIMENT 70 can include or can optionally be combined with the subject matter of one or any combination of EMBODIMENTS 64-69, to optionally include the surfactant compound having a number average molecular weight of from about 2,000 grams per mol to about 14,600 grams per mol.

EMBODIMENT 71 can include or can optionally be combined with the subject matter of one or any combination of EMBODIMENTS 64-70, to optionally include the surfactant compound having a number average molecular weight of from about 10,000 grams per mol to about 14,600 grams per mol.

EMBODIMENT 72 can include or can optionally be combined with the subject matter of one or any combination of EMBODIMENTS 64-71, to optionally include a molar ratio of the surfactant compound relative to the combined concentration of iridium and 3d orbital transition metal in the precursor and surfactant mixture being from about 0.001 to about 0.5.

EMBODIMENT 73 can include or can optionally be combined with the subject matter of one or any combination of EMBODIMENTS 64-72, to optionally include the iridium precursor compound comprising at least one of a hydrogen haloiridate, a substituted hydrogen hexahaliridate, an inorganic iridium containing compound, a soluble iridium containing organic compound; and combinations thereof.

EMBODIMENT 74 can include or can optionally be combined with the subject matter of one or any combination of EMBODIMENTS 64-72, to optionally include the iridium precursor compound comprising at least one of: hydrogen hexachloroiridate (H₂IrCl₆); hydrogen hexabromoiridate (H₂IrBr₆); potassium hexachloroiridate (K₂IrCl₆); sodium hexachloroiridate (Na₂IrCl₆); cesium hexachloroiridate (Cs₂IrCl₆); indium chloride (IrCl₃); iridium nitrate (Ir(NO₃)₃); iridium (III) acetylacetonate; bis(1,5-cyclooctadiene)iridium(I) tetrafluoroborate; chloro(1,5-cyclooctadiene)iridium(I) dimer; methoxy(1,5-cyclooctadiene)iridium(I) dimer; and combinations thereof.

EMBODIMENT 75 can include or can optionally be combined with the subject matter of one or any combination of EMBODIMENTS 64-74, to optionally include the 3d orbital transition metal compound comprising a transition metal having an atomic number from 21 to 31.

EMBODIMENT 76 can include or can optionally be combined with the subject matter of one or any combination of EMBODIMENTS 64-75, to optionally include the 3d orbital transition metal compound comprising at least one of scandium (Sc), titanium (Ti), vanadium (V), chromium (Cr), manganese (Mn), iron (Fe), cobalt (Co), nickel (Ni), copper (Cu), and zinc (Zn).

EMBODIMENT 77 can include or can optionally be combined with the subject matter of one or any combination of EMBODIMENTS 64-76, to optionally include the catalyst particles resulting from step (e) comprising a doped iridium oxide having the formula:

IrₓM₁₋ₓO_{y}

wherein x is a number more than 0 and less than 1, M is a 3d orbital transition metal from the 3d orbital transition metal compound, and y is a number less than 2.

EMBODIMENT 78 can include or can optionally be combined with the subject matter of one or any combination of EMBODIMENTS 64-77, to optionally include after step (c), (f) heating the metal precursor and surfactant mixture to an aggregation temperature.

EMBODIMENT 79 can include or can optionally be combined with the subject matter of EMBODIMENT 78, to optionally include the heating of step (f) resulting in the formation of aggregated micelles of iridium, 3d orbital transition metal, and the surfactant compound.

EMBODIMENT 80 can include or can optionally be combined with the subject matter of one or any combination of EMBODIMENT 78 and EMBODIMENT 79, to optionally include the aggregation temperature of step (e) being from about 20° C. to about 100° C.

EMBODIMENT 81 can include or can optionally be combined with the subject matter of one or any combination of EMBODIMENT 78 and EMBODIMENT 79, to optionally include the aggregation temperature of step (f) being from about 40° C. to about 99° C.

EMBODIMENT 82 can include or can optionally be combined with the subject matter of one or any combination of EMBODIMENTS 64-81, to optionally include the nitrate salt of the alkaline metal cation of step (d) comprising at least one of lithium nitrate (LiNO₃), sodium nitrate (NaNO₃), potassium nitrate (KNO₃), rubidium nitrate (RbNO₃), and cesium nitrate (CsNO₃).

EMBODIMENT 83 can include or can optionally be combined with the subject matter of one or any combination of EMBODIMENTS 64-82, to optionally include a weight ratio of the nitrate salt of the alkaline metal cation relative to the iridium precursor compound reacted in step (d) being from about 5:1 to about 200:1.

EMBODIMENT 84 can include or can optionally be combined with the subject matter of one or any combination of EMBODIMENTS 64-85, to optionally include step (d) resulting in an intermediate iridium nitrate solution, the method further comprising, before step (e): (g) drying the intermediate indium nitrate solution to provide a powder that includes iridium nitrate.

EMBODIMENT 85 can include or can optionally be combined with the subject matter of EMBODIMENT 84, to optionally include the drying of step (g) being performed at a drying temperature of from about 40° C. to about 99° C.

EMBODIMENT 86 can include or can optionally be combined with the subject matter of one or any combination of EMBODIMENTS 64-85, to optionally include the calcination temperature in step (e) being from about 200° C. to about 600° C.

EMBODIMENT 87 can include or can optionally be combined with the subject matter of one or any combination of EMBODIMENTS 64-86, to optionally include (h) washing the catalyst particles with one or more cycles of water, one or more alcohols, or a combination thereof to provide washed catalyst particles.

EMBODIMENT 88 can include or can optionally be combined with the subject matter of EMBODIMENT 87, to optionally include cooling the catalyst particles to room temperature before step (h).

EMBODIMENT 89 can include or can optionally be combined with the subject matter of one or any combination of EMBODIMENT 87 and EMBODIMENT 88, to optionally include step (h) comprising centrifugal separation of the washed catalyst particles from the water, the one or more alcohols, or the combination thereof.

EMBODIMENT 90 can include or can optionally be combined with the subject matter of one or any combination of EMBODIMENTS 87-89, to optionally include drying the washed catalyst particles.

EMBODIMENT 91 can include or can optionally be combined with the subject matter of one or any combination of EMBODIMENTS 64-90, to optionally include (i) acid-etching the catalyst particles.

EMBODIMENT 92 can include or can optionally be combined with the subject matter of EMBODIMENT 91, to optionally include the acid-etching of step (i) removing at least a portion of the 3d orbital transition metal away from the iridium oxide in the catalyst particles.

EMBODIMENT 93 can include or can optionally be combined with the subject matter of one or any combination of EMBODIMENT 91 and EMBODIMENT 92, to optionally include the acid etching of step (i) comprising treating the catalyst particles with hydrochloric acid (HCl), hydrofluoric acid (HF), hydrobromic acid (HBr), sulfuric acid (H₂SO₄), nitric acid (HNO₃), phosphoric acid (H₃PO₄), perchloric acid (HClO₄), or a combination thereof.

EMBODIMENT 94 can include or can optionally be combined with the subject matter of one or any combination of EMBODIMENTS 64-93, to optionally include after step (c), allowing the surfactant compound to aggregate into micelles comprising a plurality of molecules of the surfactant compound at least partially surrounding a portion of the iridium precursor compound and a portion of the 3d orbital transition metal.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

1. A method of fabricating a catalyst material, the method comprising:
(a) forming or receiving a precursor solution of an iridium precursor compound;
(b) adding a 3d orbital transition metal compound to the precursor solution;
(c) adding a surfactant compound to the precursor solution to provide a precursor and surfactant mixture;
(d) adding a nitrate salt of an alkaline metal cation to the precursor and surfactant mixture so that the iridium precursor compound reacts with the nitrate salt of the alkaline metal cation to provide a reaction product comprising an iridium nitrate; and
(e) calcining the iridium nitrate at a specified calcination temperature to convert the iridium nitrate to form catalyst particles comprising iridium oxide.

2. A method according to claim 1, wherein the iridium precursor compound comprises at least one of a hydrogen haloiridate, a substituted hydrogen hexahaliridate, an inorganic iridium containing compound, a soluble iridium containing organic compound; and combinations thereof.

3. (canceled)

4. (canceled)

5. A method according to claim 1, wherein the catalyst particles resulting from step (e) comprise a doped iridium oxide having the formula
IrₓM₁₋ₓO_{y}
wherein x is a number more than 0 and less than 1, M is a 3d orbital transition metal from the 3d orbital transition metal compound, and y is a number less than 2.

6. A method according to claim 1, wherein the surfactant compound in step (c) comprises an amphiphilic compound.

7. A method according to claim 1, further comprising, after step (c), (f) heating the metal precursor and surfactant mixture to an aggregation temperature.

8. (canceled)

9. A method according to claim 1, wherein the calcination temperature in step (e) is from about 200° C. to about 600° C.

10. A method according to claim 1, further comprising:
(i) acid-etching the catalyst particles to remove at least a portion of the 3d orbital transition metal away from the iridium oxide in the catalyst particles.

11. A method according to claim 1, further comprising, after step (c), allowing the surfactant compound to aggregate into micelles comprising a plurality of molecules of the surfactant compound at least partially surrounding a portion of the iridium precursor compound and a portion of the 3d orbital transition metal.

12. A method of fabricating a catalyst material, the method comprising:
(a) forming or receiving a precursor solution of an iridium precursor compound;
(b) adding a 3d orbital transition metal compound to the precursor solution;
(c) adding a surfactant compound to the precursor solution to provide a precursor and surfactant mixture;
(d) heating the metal precursor and surfactant mixture to an aggregation temperature of from about 20° C. to about 100° C. to form micelles comprising the iridium precursor compound and the 3d orbital transition metal at least partially surrounded by the surfactant compound;
(e) adding a nitrate salt of an alkaline metal cations to the precursor and surfactant mixture so that the iridium precursor compound reacts with the nitrate salt of the alkaline metal cation to provide a reaction product comprising an iridium nitrate; and
(f) calcining the iridium nitrate at a specified calcination temperature to convert the iridium nitrate to form catalyst particles comprising an iridium oxide.

13. A method according to claim 12, wherein the aggregation temperature of step (d) is from about 40° C. to about 99° C.

14. A method according to claim 12, wherein the iridium precursor compound comprises at least one of a hydrogen haloiridate, a substituted hydrogen hexahaliridate, an inorganic iridium containing compound, a soluble iridium containing organic compound; and combinations thereof.

15-17. (canceled)

18. A method of fabricating a catalyst material, the method comprising:
(a) forming or receiving a precursor solution of an iridium precursor compound;
(b) adding a 3d orbital transition metal compound to the precursor solution;
(c) adding a surfactant compound to the precursor solution to provide a precursor and surfactant mixture, wherein the surfactant compound comprises an amphiphilic compound having one or more hydrophilic groups and one or more hydrophobic groups;
(d) adding a nitrate salt of an alkaline metal cation to the precursor and surfactant mixture so that the iridium precursor compound reacts with the nitrate salt of the alkaline metal cation to provide a reaction product comprising iridium nitrate; and
(e) calcining the iridium nitrate at a specified calcination temperature to convert the iridium nitrate to form catalyst particles comprising an iridium oxide.

19. A method according to claim 18, wherein the surfactant compound in step (c) comprises a nonionic triblock copolymer with a polymer chain comprising hydrophilic end blocks at ends of the polymer chain and a hydrophobic block between the hydrophilic end blocks.

20. A method according to claim 18, wherein the surfactant compound in step (c) comprises a triblock polymer with a polymer chain comprising poly(ethylene oxide) blocks at ends of the polymer chain and a poly(propylene oxide) block between the poly(ethylene oxide) end blocks.

21. A method according to claim 20, wherein a relative weight of the poly(ethylene oxide) blocks is defined by the formula
$${W}_{PEO} = \frac{wt {\%}_{PEO}}{wt {\%}_{PEO} + wt {\%}_{PPO}}$$
wherein wt %_{PEO} is the weight percentage of the poly(ethylene oxide) blocks in the triblock polymer and wt %_{PPO} is the weight percentage of the poly(propylene oxide) block in the triblock polymer, wherein W_{PEO} is from about 0.2 to about 0.8.

22. A method according to claim 21, wherein W_{PEO} is from about 0.6 to about 0.8.

23. A method according to claim 18, wherein the surfactant compound has a number average molecular weight of from about 2,000 grams per mol to about 14,600 grams per mol.

24. A method according to 18, wherein the surfactant compound has a number average molecular weight of from about 10,000 grams per mol to about 14,600 grams per mol.

25. A method according to claim 18, wherein a molar ratio of the surfactant compound relative to the combined concentration of iridium and 3d orbital transition metal in the precursor and surfactant mixture is from about 0.001 to about 0.5.

26-28. (canceled)

29. A method according to claim 18, further comprising, after step (c), allowing the surfactant compound to aggregate into micelles comprising a plurality of molecules of the surfactant compound at least partially surrounding a portion of the iridium precursor compound and a portion of the 3d orbital transition metal.
